(19) United States
(12) Patent Application Publication
(10) Pub. No.: US 2011/0298923 A1
(43) Pub. Date: Dec. 8, 2011

(54) MOVING OBJECT IMAGE CAPTURE SYSTEM, MOVING OBJECT, GROUND STATION APPARATUS, AND MOVING OBJECT IMAGE CAPTURE METHOD

(76) Inventor: Hisayuki Mukae, Tokyo (JP)

(21) Appl. No.: 13/202,289

(22) PCT Filed: Feb. 26, 2009
(86) PCT No.: PCT/JP2009/053519

§ 371 Date: Aug. 18, 2011

(51) Int. Cl. H04N 7/18

(52) U.S. Cl. 348/144; 348/E07.085

(57) ABSTRACT

A moving object image capture system 100 that captures an image of a moving object includes flying vehicles 1 each of which mounts a camera that captures an image of an earth surface, and captures an image of the earth surface locating a specified coordinate position by the camera; a moving object 9 which receives distance measurement radio waves transmitted from navigation satellites to measure a coordinate position of the moving object 9 and transmits an image capture request signal for requesting image-taking of the earth surface locating the measured coordinate position; and a ground station apparatus 12 which receives the image capture request signal from the moving object, transmits an image capture instruction signal including the coordinate position of the moving object to one of the flying vehicles, causes the camera mounted on the flying vehicle to capture the image of the earth surface locating the coordinate position of the moving object, and receives from the flying vehicle imagery data obtained by the image capture by the camera.

### TECHNICAL FIELD

The present invention relates to a system for image-capturing an earth surface from a camera of an artificial satellite. More specifically, the invention relates to a moving object image capture system and a moving object image capture method for obtaining image information on a location at which a moving object is present, by using the camera.

### BACKGROUND ART

Among related art monitoring apparatuses, there is a monitoring apparatus for monitoring a fixed point on the ground.

To take an example, there is known the monitoring apparatus in which, using software for converting the coordinate position of an already-known monitoring target to a coordinate position based on a coordinate system adopted by the navigation satellite, an on-board computer controls an attitude control actuator, with the coordinate position of the monitoring target calculated by the software used as a target value for the control.

In this apparatus, a flying vehicle mounts a camera pointing to an earth surface, the attitude control actuator for changing an attitude of the flying vehicle, and the on-board computer for analyzing a deviation between a position and an attitude angle of the flying vehicle and the target value planned in advance for flying and generating for the attitude control actuator a control signal for changing the attitude.

There is also known a moving object monitoring system in which information (position, course, speed, and an information collection time) on a ship is collected on the ship, the collected information is transmitted to a ship monitoring observation satellite, and the ship monitoring observation satellite transmits the information on the ship, the position and attitude of the satellite, a collected information transmission time, and image data to a monitoring apparatus on the ground. The monitoring apparatus receives the respective data, and displays a combination of the respective data on one screen. With that arrangement, distinction between a monitoring target moving object and a moving object not targeted for monitoring may be made.
Patent Document 1: Japanese Publication Patent Application No. 11-98492
Patent Document 2: Japanese Published Patent Application No. 9-35200
Patent Document 3: Japanese Published Patent Application No. 2004-37323
Patent Document 4: Japanese Published Patent Application No. 11-136661
Patent Document 5: Japanese Published Patent Application No. 11-86196
Patent Document 6: Japanese Published Patent Application No. 11-51688
Patent Document 7: Japanese Published Patent Application No. 2000-162315
Patent Document 8: Japanese Published Patent Application No. 9-89558

### DISCLOSURE OF INVENTION

### Problems to be Solved by Invention

The related art monitoring apparatus has the following problem. That is, the coordinate position of the monitoring target is fixed. Thus, when the monitoring target moves, the related art monitoring apparatus cannot monitor the monitoring target.

The related art moving object monitoring system has the following problem. That is, though the related art moving object monitoring system may distinguish whether a moving object in a monitoring zone is the monitoring target moving object or the moving object not targeted for monitoring, the related art moving object monitoring system cannot monitor a monitoring target when the monitoring target moves.

The present invention has been made to improve the problems as described above. An object of the present invention is to provide a system capable of grasping a state of a moving object in a moving destination when the moving object has moved to the moving destination.

### Means for Solution to Problems

A moving object image capture system according to the present invention is a moving object image capture system which captures an image of a moving object. The system may include:

flying vehicles each of which includes a camera that captures an image of an earth surface and captures an image of the earth surface locating a specified coordinate position by the camera;

a moving object which receives distance measurement radio waves transmitted from navigation satellites to measure a coordinate position of the moving object and transmits an image capture request signal for requesting taking an image of the earth surface locating the measured coordinate position; and

a ground station apparatus which receives the image capture request signal from the moving object, selects one of the flying vehicles which takes the image of the earth surface locating the coordinate position of the moving object, transmits an image-taking instruction signal for taking the image locating the coordinate position of the moving object to the selected flying vehicle, causes the camera mounted on the flying vehicle to capture the image of the earth surface locating the coordinate position of the moving object, and receives from the flying vehicle imagery data obtained by the image capture by the camera.

The moving object may include:

a moving object receiving unit which receives the distance measurement radio waves transmitted from the navigation satellites to measure the coordinate position; and

a request determination unit which determines whether or not the moving object has moved by a predetermined threshold or more, based on the coordinate position, and generates the image capture request signal.

The ground station apparatus may include:

a flying vehicle database which stores operation information on the flying vehicles; and

an image-taking instruction unit which receives the image capture request signal from the moving object, selects a plurality of the flying vehicles based on the operation information stored in the flying vehicle database, and transmits the image-taking instruction signal to the selected flying vehicles.

The ground station apparatus may include:

a map database which stores map information; and

an image synthesis unit which selects one of the map information corresponding to the imagery data from the map information stored in the map database and synthesizes the imagery data and the map information.

The ground station apparatus may include:

an image database which records imagery data taken in the past as recorded images: and

an image synthesis unit which selects one of the imagery data taken in the past corresponding to the imagery data from among the recorded images stored in the image database and synthesizes the imagery data and the recorded image.

The moving object may generate and may transmit the image capture request signal including transfer destination information indicating a transfer destination device to which the imagery data from the ground station apparatus is transferred; and

the ground station apparatus may include a transfer unit which generates transfer image information including the imagery data received from the flying vehicle and transfers the transfer image information to the transfer destination device indicated by the transfer destination information included in the image capture request signal transmitted by the moving object.

The flying vehicle may take a plurality of images obtained by changing image-taking specifications of the camera.

The moving object image capture system may further include a communication satellite which receives the image capture request signal transmitted by the moving object and transmits the image capture request signal to the ground station apparatus.

The moving object image capture system may include a quasi-zenith satellite;

wherein the quasi-zenith satellite is at least one of one of the navigation satellites and the flying vehicle.

A moving object according to the present invention may include:

a moving object receiving unit which receives distance measurement radio waves transmitted from navigation satellites to measure a coordinate position of a moving object;

a request determination unit which determines whether or not the moving object has moved by a predetermined threshold or more, based on the coordinate position measured by the moving object receiving unit, and generates an image capture request signal for image-capturing the coordinate position; and

an image capture request transmission unit which transmits the image capture request signal for taking an image of an earth surface locating the coordinate position measured by the moving object receiving unit, based on a result of the determination by the request determination unit.

A ground station apparatus according to the present invention may include:

an image capture instruction unit which receives from a moving object an image capture request signal including a coordinate position of the moving object, transmits an image-taking instruction signal including the coordinate position of the moving object to a flying vehicle, and causes a camera mounted on the flying vehicle to capture an image of an earth surface locating the coordinate position of the moving object; and

a transfer unit which receives from the flying vehicle imagery data obtained by the image capture by the camera, generates transfer information including the imagery data, and transfers the transfer information to at least one of the moving object and a transfer destination device.

A moving object image capture method according to the present invention is a moving object image capture method of a moving object image capture system which captures an image of a moving object. The method may include:

by a moving object which receives distance measurement radio waves transmitted from navigation satellites and measures a coordinate position, transmitting an image capture request signal for requesting taking an image of an earth surface locating a measured coordinate position of a moving object;

by a ground station apparatus, receiving the image capture request signal from the moving object, selecting a flying vehicle which takes the image of the earth surface locating the coordinate position of the moving object, transmitting an image-taking instruction signal for taking the image locating the coordinate position of the moving object, and instructing a camera mounted on the flying vehicle to capture the image of the earth surface locating the coordinate position of the moving object;

by the flying vehicle, receiving the image-taking instruction signal, capturing the image of the earth surface locating the coordinate position specified by the image-taking instruction signal using a camera which is mounted on the flying vehicle and captures an image of the earth surface, and transmitting the imagery data to the ground station apparatus; and

by the ground station apparatus, receiving from the flying vehicle the imagery data obtained by the image-capturing by the camera.

### Advantageous Effect of Invention

According to each embodiment of the present invention, there is an effect that the moving object may be promptly and flexibly monitored in real time even if the moving object has moved, and that data may be promptly obtained at a time of occurrence of a disaster or in response to an emergency.

### BEST MODE FOR CARRYING OUT INVENTION

### First Embodiment

An outline of a moving object image capture system in a first embodiment will be described.

### 1. Collaboration of Positioning, Communication, and Observation

### (1) Basic Concept of Moving Object Image Capture System

By instructing a flying vehicle such as an observation satellite to take an image of an earth surface at the coordination position of an image capture target (moving object), image capture by the flying vehicle such as the observation satellite is specified. Using the instruction about the coordinate position, the observation satellite captures the image of the image capture target (moving object).

The position of the image capture target (moving object) is measured by a positioning satellite. As the coordinate position, coordinates by a GPS (global positioning system) adopted by the positioning satellite or coordinates by a Galileo Positioning System are used.

The coordinate position of the image capture target (moving object) is obtained by the positioning satellite, and the coordinate position of the image capture target (moving object) is transmitted to the observation satellite, after being relayed by a wireless communication line, the Internet, or a communication satellite.

The coordinate position is provided together with geographic information, the position information may be the coordinate position of a coordinate system used by navigation satellites or latitude and longitude information

As the coordinate system adopted by the navigation satellites, a geodetic coordinate system referred to as a World Geodetic System 84 (WGS 84), for example, may be pointed out.

When the position of the image capture target can be measured, image capture of the image capture target may be specified even if the image capture target is a fixed target such as a building or a portable object as well as the moving object. That is, the image capture target is not limited to the moving object which moves itself and a cellular phone carried by a human.

### (2) On-the-Demand Interactive System

The moving object image capture system in this embodiment makes a shutter control authority of a camera of an observation satellite public. In the moving object image capture system of this embodiment, a moving object or a user directly instructs image capture of an earth surface using the camera of the observation satellite, and the observation satellite controls the interactive image capturing over the specified position.

In an actual system operation, however, it is preferable that a robust automation system be constructed to avoid the satellite from being hijacked and being out of control, and it is also preferable that an image capture priority, an image capture order, and a shared image capture by a plurality of satellites be set by preparation of an image capture plan for image capture requests.

The moving object image capture system in this embodiment uses a virtual space presented by a WEB. The moving object image capture system in this embodiment uses the virtual space presented by the Internet so as to achieve both of interactivity from the user's point of view and practical satellite system robustness.

### (3) Real-Time Feature

In the moving object image capture system of this embodiment, it is desirable that the sufficient number of observation satellites (flying vehicles) such as orbiting satellites are available.

When a function of setting GPS coordinates to an image capture target and an on-the-demand operation of the camera installed on the satellite are authorized, it is possible for the moving object image capture system in this embodiment to cooperate with observation satellites all over the world. It is essentially preferable that real-time feature be ensured in the moving object image capture system in this embodiment. In order to ensure the real-time feature, a stationary observation satellite or a quasi-zenith satellite which constantly flies in the sky above a predetermined region is used. In the case of the stationary observation satellite in the sky above the equator, the real-time feature is feasible when a monitoring target is large like a ship. When resolution is improved in the future due to technological development for increasing image capture resolution of the stationary observation satellite, utilization of the stationary observation satellite is increased.

A captured image from a stationary orbit in the sky above the equator is obtained by obliquely viewing an earth surface. Accordingly, observation from a quasi-zenith orbit is preferable.

### 2. Added Value as Information System

### (1) Value of Satellite Image

The moving object image capture system in this embodiment has an advantage of visibility using a satellite image. By linking to an emergency response organization system or other information sources, the added value is further improved comparing with the added value by a satellite image alone.

(2) Linkage with GIS (Geographic Information System)

When the moving object image capture system in this embodiment links with GIS information, as an information system, an added value is further given to a satellite image. When a linkage is made with the GIS information, the moving object image capture system in this embodiment utilizes the Internet so as to make access to a database system in which the GIS information is stored.

Details of the moving object image capture system in this embodiment will be described below.

FIG. 1 is a configuration diagram of a moving object image capture system 100 showing a first embodiment of the present invention. The moving object image capture system 100 showing the first embodiment of the present invention is operated by the following configuration.

### (1) System Configuration

The moving object image capture system 100 is mainly configured by a moving object 9, a ground station apparatus 12, and flying vehicles 1. A specific example of each of the flying vehicles 1 is an observation satellite.

### (2) System Operation

The ground station apparatus 12 receives an image capture request signal 83 including an emergency signal from the moving object 9 such as a cellular phone through a ground wireless line.

The ground station apparatus 12 automatically makes an image capture plan targeting image capture of a coordinate position of the moving object 9. The ground station apparatus 12 transmits an image capture instruction signal 71 to one of the flying vehicles 1. The flying vehicle 1 takes an image of an earth surface targeting the image capture of the coordinate position of the moving object 9.

The ground station apparatus 12 receives imagery data 72 from the flying vehicle 1 after image capture by the flying vehicle 1, and transmits the imagery data 72 to the moving object 9 and a transfer destination device 29 such as an emergency response organization.

FIG. 1 illustrates the following components:

flying vehicles 1a, 1b, . . . and the like (hereinafter just referred to as the flying vehicles 1) such as an artificial satellite, an airplane, and an airship;

a camera 2 which is mounted on each of the flying vehicles 1 and points to an earth surface;

a plurality of navigation satellites 3a, 3b, . . . (hereinafter just referred to as navigation satellites 3) for each of which an orbit position is already known and for each of which a distance measurement radio wave (navigation satellite signal) generated at the orbit position based on an radio wave propagation time is already known;

a flying vehicle receiver 4 mounted on the flying vehicle 1, which receives distance measurement radio waves (navigation satellite signals) supplied from a plurality of the navigation satellites 3 to analyze the coordinate position of the flying vehicle 1;

an attitude sensor 5 which detects an attitude of the flying vehicle 1;

an attitude control actuator 6 mounted on the flying vehicle 1, which changes the attitude of the flying vehicle 1;

a view direction change device 7 mounted on the camera 2, which changes a sight line direction of the camera 2;

an on-board computer 8 mounted on the flying vehicle 1;

the moving object 9;

an earth 10;

a sight line 11 of the camera;

the ground station apparatus 12 installed on the ground;

a ground computer 13 installed on the ground station apparatus 12;

a map database 14 which stores map information such as geographic information and position information on various places on the earth;

a terminal 15 connected to the ground computer on the ground station apparatus 12 through a signal transmission path;

a flying vehicle database 16 which stores operation information on the flying vehicles 1;

an image database 17 which stores imagery data taken in the past as a recorded image; and

a transfer destination device 29 which is an electronic computer device installed in a rescue unit, a police, a fire station, or a hospital, which receives transfer image information 75 from the ground computer 13, displays imagery data obtained by taking an image of the moving object, and generates a monitoring instruction or a rescue instruction according to the situation in the vicinity of the moving object.

### “Explanation of Moving Object 9”

The moving object 9 includes a moving object receiving unit 91, a request determination unit 92, an image capture request transmission unit 93, a display screen 94, and an emergency switch 99.

The moving object 9 is a cellular phone, an in-vehicle device, a radio device of a ship, a radio device of an airplane, or a portable radio device, for example.

The moving object 9 may be a device which autonomously moves itself, or a device mounted on a moving entity or moved together with the moving entity. The moving object 9 may be a portable device, or a device capable of being carried in and out.

Further, the moving object 9 may be a fixed entity such as a building if the position of the target for image capture may be measured. The moving object 9 may be an airport, a port, or a station. The moving object 9 may be an equipment installed on a building or placed on the ground, not limiting to the fixed entity. To take an example, the moving object 9 may be an electronic computer, an antenna, or a radio wave tower.

A specific example of the moving object 9 in particular may be the cellular phone, the in-vehicle device, a ship-based aircraft, or a portable-type wireless communication device in a region where a disaster has occurred or a region for which monitoring is necessary.

The moving object receiving unit 91 receives the distance measurement radio waves (navigation satellite signals) transmitted from the plurality of navigation satellites 3 to analyze the coordinate position of the moving object 9.

The request determination unit 92 determines whether or not the moving object has moved by a predetermined threshold or more, based on a coordinate position 81, generates a transmission instruction 82, and outputs the transmission instruction 82 to the image capture request transmission unit 93. The image capture request transmission unit 93 generates the image capture request signal 83 for image-capturing the coordinate position. The image capture request signal 83 further includes the emergency signal and information on an image transfer destination for transferring the imagery data from the ground station apparatus.

The image capture request transmission unit 93 transmits the image capture request signal 83.

A communication unit 95 is a wireless communication unit which performs communication with another wireless communication device.

The emergency switch 99 is a button an operator of the moving object 9 depresses in case of emergency or crisis.

In the method of specifying the self-position of the moving object 9, the coordinate position 81 obtained from positioning information obtained by the moving object receiving unit 91 is used. Specifically, there are the following cases:

1. A GPS receiving function and a transmitter are added to one of the following belongings of an individual;

a watch, a cellular phone, a portable terminal, and a personal computer

2. A GPS receiver and a transmitter are included in one of the following vehicles;

a taxi, a home delivery truck, a transportation truck, a private car, a motorcycle, and a bicycle

3. A GPS receiver and a transmitter are included in one of the following ships;

a tanker, a fishing boat, a yacht, and a cruiser

4. A GPS receiver and a transmitter are included in one of the following airplanes;

a passenger airplane, a business jet plane, a light aircraft for an individual, a glider, and an airship

### “Explanation of Flying Vehicle 1”

The flying vehicle 1 is an observation satellite which goes around the earth in a low orbit, an artificial satellite such as a meteorological satellite which observes the earth from a stationary orbit, an airplane for aerial triangulation, an airship for observation of the earth, a helicopter, a commercial airplane, or the like.

As the camera 2, a visible optical sensor for obtaining a visual image, an imaging radar such as a synthetic aperture radar, a microwave radiometer, an infrared sensor, or an ultraviolet sensor may be used.

Positions of the navigation satellites 3, the flying vehicles 1, and an arbitrary position on the earth 10 may be uniquely represented by the coordinate system adopted by the navigation satellites 3. Thus, using the coordinate position of each flying vehicle 1 analyzed by the flying vehicle receiver 4 and the attitude information detected by the attitude sensor 5, the starting point and the direction of a sight line 11 of the camera may be determined as the coordinate position and the direction vector of the coordinate system adopted by the navigation satellites 3.

### “Explanation of Ground Station Apparatus 12”

A tracking control station or a satellite signal receiving station of an artificial satellite is a candidate for the ground station apparatus 12. In addition to this, by utilizing personal computers as the terminal 15 and the ground computer 13 at a local government organization, at an enterprise, or at an individual's home, the personal computers may be used as the ground station apparatus 12.

The ground computer 13 is installed on the ground station apparatus 12. The ground computer 13 includes a central processing unit, a memory with software stored therein, and a recording unit for recording data. The ground computer 13 performs an operation of by executing the software stored in the memory, an operation of accessing various databases, and an operation of each unit, and a communicating operation with an outside.

The ground computer 13 further includes an image capture instruction unit 31, an image synthesis unit 32, and a transfer unit 33.

The image capture instruction unit 31 receives the image capture request signal 83 from the moving object 9, selects at least one of the flying vehicles 1 based on the operation information in the flying vehicle database 16, and transmits the image capture instruction signal 71 to the selected flying vehicle 1.

The image synthesis unit 32 selects map information corresponding to the imagery data from among the map information in the map database 14 and synthesizes the imagery data and the map information.

The image synthesis unit 32 selects imagery data in the past corresponding to the imagery data from the recorded images in the image database 17 and synthesizes the imagery data and the recorded image.

The image synthesis unit 32 generates synthesized image information 73 and outputs the synthesized image information 73 to the transfer unit 33.

The transfer unit 33 receives the synthesized image information 73 from the image synthesis unit 32, generates the transfer image information 75 including the imagery data received from the flying vehicle 1 based on the synthesized image information 73, and transfers the transfer image information 75 to the moving object 9 or the transfer destination device 29 included in the image capture request signal 83 transmitted by the moving object 9.

The map database 14 may be the one including locally databased map information. Alternatively, a database such as a GIS (Geographic Information System) connected to the Internet may be used.

The flying vehicle database 16 stores the operation information on the flying vehicles 1 of different types.

The flying vehicle database 16 stores the following operation information on the flying vehicles 1, for example:

1. orbit information on observation satellites;
2. information on stationary orbits of stationary satellites;
3. information on the operation plan of airplanes for aerial triangulation;
4. information on the flight plan of airships for earth observation; and
5. information on the operation plan of airplanes and helicopters for disaster relief.

The flying vehicle database 16 stores the following information as the operation information and flight information. Alternatively, the following flight information on the flying vehicle 1 may be calculated from the operation information stored in the flying vehicle database 16:

1. flight speed;
2. flight route (flight orbit);
3. flight position;
4. flight altitude;
5. flight attitude; and
6. capability of changing the attitude sensor 5 of the flying vehicle 1, and a method and an instruction parameter for the change when the change can be made.

The flying vehicle database 16 stores, for each flying vehicle 1, specification information on the camera 2 and the view direction change device 7 mounted on each flying vehicle 1, together with the operation information. The specification information on the camera 2 and the view direction change device 7 includes the following:

1. resolution;
2. view field angle;
3. capability of zooming and zoom factor;
4. image capture time interval;
5. the number of images that may be captured; and
6. capability of changing view field direction and view field direction changeable range.

The image database 17 stores the imagery data 72 obtained by image capture by the flying vehicle 1 so that the imagery data 72 may be retrievable, using the coordinate position as a key.

The image database 17 receives a search request using a coordinate position (X1, Y1, Z1) as the key, and all images, obtained in the past, of an earth surface on which the coordinate position (X1, Y1, Z1) is located may be searched.

The image database 17 stores the imagery data 72 obtained by taking an image of a coordinate position (X0, Y0, Z0), together with an image-taking range, for example. When the search request using the coordinate position (X1, Y1, Z1) as the key is received at a later date, in case that the coordinate position (X1, Y1, Z1) is included in the range of the imagery data 72 obtained by taking the image of the coordinate position (X0, Y0, Z0), the image database 17 outputs the imagery data 72 obtained by taking the image of the coordinate position (X0, Y0, Z0) as a search result.

The image database 17 may store an image of the earth surface created by a different system in advance, rather than the imagery data 72 obtained by image capture by the flying vehicle 1.

The terminal 15 does not need to be installed in the ground station apparatus 12 on which the ground computer 13 is installed, and may be connected to the ground computer 13 using a telephone line or a satellite line as a signal transmission path.

The terminal 15 may also be used as the ground computer 13 as well, like the personal computer.

The software is operated at the terminal 15 to make access to the ground computer 13 and various databases. The memory which stores the various databases and the software does not need to be installed in the ground station apparatus 12 on which the ground computer 13 is installed. The software and the databases may be downloaded from another ground station apparatus 12 through a network such as the Internet. An operation of transmitting an analysis result or a process result to the flying vehicle 1 may be performed through the another ground station apparatus 12

### “Explanation of Attitude Change Amount of Flying Vehicle 1”

A method of determining an attitude change amount using a coordinate position as a target value will be explained with reference to FIG. 2.

Referring to FIG. 2, a coordinate system 21 is adopted. In the coordinate system 21, the center of gravity of the earth 10 is set to a coordinate origin 20, and a three-dimensional coordinate position of each navigation satellite is represented by three parameters X, Y, Z.

An angle 22a is a first target angle formed between an X-axis direction and the cosine of the sight line direction of the camera, in a plane formed by the X-axis direction and a Y-axis direction of the coordinate system 21.

An angle 22b is a second target angle formed between the Y-axis direction and the sight line 11 of the camera, in a plane orthogonal to the plane in which the first target angle 22a is formed.

The coordinate origin 20 is set to (0, 0, 0), and the coordinate positions of the moving object 9 and the flying vehicle 1 are uniquely determined as (X1, Y1, Z1) and (X2, Y2, Z2), respectively.

The direction of the sight line 11 of the camera is given by a vector (sight line vector) connecting the coordinate position (X2, Y2, Z2) of the flying vehicle 1 and the coordinate position (X1, Y1, Z1) of the moving object 9. Accordingly, a target angle for causing the sight line 11 of the camera to point to the moving object 9 is uniquely determined using the first target angle 22a and the second target angle 22b.

The direction pointed to by the flying vehicle 1 is measured by the attitude sensor 5 and analyzed by the on-board computer 8, in advance. When a difference between the direction pointed to by the flying vehicle 1 and the first target angle 22a and a difference between the direction pointed to by the flying vehicle 1 and the second target angle 22a are respectively obtained, an attitude change amount to be instructed by the on-board computer 8 to the attitude control actuator 6 is determined.

The example where two parameters are used for the angles related to the attitude change amount has been explained. Needless to say, three angle components may be used by addition of a parameter of a rotation component of the sight line vector.

### “Explanation of Operation of Flying Vehicle 1”

A processing in the on-board computer 8 will be described with reference to FIG. 3.

Reference numeral d1 denotes an operation 1 of giving an initial value showing a relative angle between the flying vehicle 1 and the direction of the sight line 11 of the camera. Reference numeral d2 denotes an operation 2 of calculating the sight line vector of the camera 2, reference numeral d3 denotes an operation 3 of calculating a target sight line vector, and reference numeral d4 denotes an operation 4 of giving attitude angle change amounts.

Referring to FIG. 3, the on-board computer 8 calculates the sight line vector of the camera at a specific moment, as the operation 2, based on the coordinate position X2, Y2, and Z2 of the flying vehicle 1 received from the flying vehicle receiver 4, attitude angles φ2, θ2, and λ2 of the flying vehicle received from the attitude sensor 5, and the initial value indicating the relative angle between the flying vehicle 1 and the direction of the sight line 11 of the camera which is recorded in advance inside the on-board computer 8 as the operation 1.

Similarly, the on-board computer 8 calculates a target sight line vector (X1-X2, Y1-Y2, Z1-Z2) as the operation 3, based on the coordinate position X2, Y2, Z2 of the flying vehicle 1 received from the flying vehicle receiver 4 and the received coordinate position X1, Y1, Z1 of the moving object 9, as the operation 3.

Then, a difference between the sight line vector of the camera and the target sight line vector is obtained, thereby calculating attitude angle change amounts Δφ, Δθ, and Δλ, as the operation 4.

These attitude angle change amounts Δφ, Δθ, and Δλ are transmitted to the attitude control actuator 6, as control parameters.

The direction of the sight line 11 of the camera may be changed by the view direction change device 7, rather than changing the attitude by the attitude control actuator 6.

The on-board computer 8 analyzes a view field direction change amount for causing the sight line 11 of the camera to point to the moving object 9. The on-board computer 8 drives the view direction change device 7. Consequently, the sight line 11 of the camera is controlled to point to the moving object 9.

For the view direction change device 7, a method of turning a reflection mirror by an optical sensor, a method of turning the sensor itself, a method of electrically changing a view field direction by a radio wave sensor, or a method of selecting a use portion of a detector may be adopted.

The direction of the sight line 11 of the camera may be changed, using the attitude control actuator 6 and the view direction change device 7.

Preferably, the direction of the sight line 11 of the camera is first changed using the view direction change device 7 rather than changing the attitude by the attitude control actuator 6, for the following reasons:

1. the change by the view direction change device 7 is easier in terms of the mechanism;
2. the change by the view direction change device 7 may be made in a shorter period of time; and
3. when the attitude is changed by the attitude control actuator 6, the need for returning the attitude to its original state after image-taking may arise.

Accordingly, when the image of the moving object 9 cannot be captured by the change in the sight line 11 of the camera by the view direction change device 7, it is preferable that the change in the direction of the sight line 11 of the camera be made using the attitude control actuator 6.

“Explanation of Method of Capturing Image of Moving Object by Moving Object Image Capture system 100”

A method of capturing the image of a moving object will be described using FIGS. 4 and 5.

“Explanation of Method of Capturing Image of Moving Object 9”

FIG. 4 is a chart showing an example of a process operation of the moving object 9 in the moving object image capture system 100 in the first embodiment.

### “S61: Trigger Step”

When an emergency occurs, the emergency switch 99 of the moving object 9 is depressed by an owner of the moving object 9. The request determination unit 92 recognizes depression of the emergency switch 99.

### “S62: Position Acquisition Step”

The moving object receiving unit 91 constantly receives a distance measurement radio wave (navigation satellite signal) transmitted from each navigation satellite 3 to measure the coordinate position of the moving object 9. The moving object receiving unit 91 outputs the coordinate position 81 of the moving object 9 to the request determination unit 92 and the image capture request transmission unit 93.

### “S63: Transmission Instruction Generation Step”

The request determination unit 92 receives the coordinate position 81 from the moving object receiving unit 91, recognizes that the emergency has occurred, generates the transmission instruction 82, and then outputs the transmission instruction 82 to the image capture request transmission unit 93. The request determination unit 92 stores the coordinate position 81, the transmission instruction 82, and the transmission time of the transmission instruction 82 in a memory 969.

“S64: Image Capture Request Signal Transmission Step”

The image capture request transmission unit 93 receives the coordinate position 81 and the transmission instruction 82 to generate the image capture request signal 83.

The image capture request signal 83 includes the following information:

### 1. Identification Information on Moving Object 9

As the identification information on the moving object 9, the telephone number of a cellular phone apparatus, the fleet number of a vehicle, the name of a ship, the flight number of an airplane, etc. may be used. The identification information on the moving object 9 also includes an address for wirelessly receiving response information from the ground station apparatus 12.

### 2. Coordinate Position 81 of Moving Object 9

Information on a GPS position, information on a three-dimensional position used for the navigation satellites, or latitude and longitude information may be used.

### 3. Transfer Destination Information 74 on Transfer Destination Device 29 to Which Emergency is Notified

The transfer destination information 74 on the transfer destination device 29 includes identification information on and the address of the transfer destination device 29. To take an example, the identification information on the transfer destination device 29 may be such as a police station, a fire station, a hospital, or a rescue unit. The identification information may be just a number such as 110 or 119, or a rescue signal such as SOS.

### 4. Transmission Time of and Transmission Number for Image Capture Request Signal 83

The transmission number for the image capture request signal 83 after depression of the emergency switch 99 is “1”.

### 5. Emergency Level

An emergency level is given to the moving object 9 in advance. Alternatively, the owner of the moving object 9 is able to set the emergency level according to the situation, then the owner of the moving object 9 depresses the emergency switch 99. To take an example, the emergency level is set to be high in the case of a regional disaster such as an earthquake or a Tsunami, while the emergency level is set to be low in the case of a personal disaster.

6. Telegraphic Message or Audio Message from Operator of Moving Object if Any

Further, preferably, the image capture request transmission unit 93 includes information on a cause of transmitting the image capture request signal 83 in the image capture request signal 83 when the image capture request signal 83 is generated.

The cause of transmitting the image capture request signal 83 may be an earthquake, a Tsunami, an accident, a stray child, a distress, a fire, kidnapping, wandering, etc. To take an example, it may be so arranged that the moving object 9 includes a function (such as a vibration sensor, a fire sensor, a temperature sensor, or a shock sensor) of detecting these causes, and the image capture request transmission unit 93 causes the image capture request signal 83 to include the information on the cause of transmitting the image capture request signal 83 when the moving object 9 detects one of the causes.

Alternatively, it may be so arranged that the owner of the moving object 9 supplies to the moving object 9 the information on the cause of transmitting the image capture request signal 83, in the form of a telegraphic message or an audio message.

The image capture request transmission unit 93 transmits the generated image capture request signal 83 to the ground station apparatus 12.

### “S65: Transfer Image Information Display Step”

The moving object 9 waits for the information on the response from the ground station apparatus 12. The moving object 9 receives the transfer image information 75 from the ground station apparatus 12 as the response from the ground station apparatus 12. The display screen 94 of the moving object 9 displays the transfer image information 75. The operator of the moving object 9 may see an image of the earth surface around the moving object 9 and is able to find the position of the operator and circumstances surrounding the operator.

In the case of the moving object 9 not provided with the display screen 94, image display does not need to be performed.

When the moving object 9 is not provided with the display screen 94, nor an image display function, the display screen 94 may select and output only audio information or character information included in the transfer image information. Alternatively, the transfer image information 75 from the ground station apparatus 12 to the moving object 9 may be only the audio information or the character information.

### “S66: Position Acquisition Step”

The moving object receiving unit 91 constantly measures the coordinate position of the moving object 9. After the emergency switch 99 has been depressed, the moving object receiving unit 91 constantly or periodically outputs the coordinate position 81 of the moving object 9 at a most recent time to the request determination unit 92 and the image capture request transmission unit 93, as in the position acquisition step S62.

### “S67: Determination Step”

The request determination unit 92 receives the coordinate position 81 at a current time from the moving object receiving unit 91. Then, the request determination unit 92 determines whether or not the moving object has moved by the predetermined threshold or more from the coordinate position 81 at a last output time of the transmission instruction 82 (that is, from the coordinate position 81 at the last time when the image capture request signal 83 has been transmitted to the ground station apparatus 12), the coordinate position 81 being stored in the memory 969 in the transmission instruction generation step S63.

When it is determined that the moving object 9 has satisfied a predetermined condition (or has moved by the predetermined threshold or more), the operation returns to the transmission instruction generation step S63, and the request determination unit 92 outputs the transmission instruction 82 to the image capture request transmission unit 93 again. The transmission number becomes “2”.

Further, alternatively, the request determination unit 92 stores the present coordinate position 81, the transmission instruction 82, the transmission time of the transmission instruction 82, and the transmission number in the memory 969 in order.

As the predetermined condition (predetermined threshold) used by the request determination unit 92, the following instances may be pointed out:
1. an instance where the moving object has moved by a predetermined distance set in advance or more, such as 1 km or 5 km;
2. an instance where the moving object 9 has moved outside the range of the captured image, when the transfer image information 75 is received and the range of the captured image can be computed from the captured image included in the transfer image information 75 and geographic data on the captured image;
3. an instance where it is anticipated from the current position and the moving speed of the moving object 9 that the moving object 9 is moving to outside the range of the captured image, when the transfer image information 75 is received and the range of the captured image can be computed from the captured image included in the transfer image information 75 and geographic data on the captured image;

Alternatively, the operation may be returned to the transmission instruction generation step S63 to output the transmission instruction 82 to the image capture request transmission unit 93 again when it is determined that the moving object 9 has satisfied one of predetermined conditions of the following instances:
4. an instance where the moving object 9 includes a clock, and it is determined that a certain period of time has elapsed; and
5. an instance where the moving object 9 includes a temperature sensor or a weather sensor, and a change in temperature or weather has been made.

As described above, by repetition of the operations in steps S63 to S67 by the moving object 9, it becomes possible to automatically cause the ground station apparatus 12 to obtain the image of the moving object 9 even if the moving object 9 has moved.

The operator of the moving object 9 may start the operations in FIG. 4 when he depresses the emergency switch 99. The operator of the moving object 9 may cause the ground station apparatus 12 to obtain the image of the moving object 9 whenever necessary.

The operation of the request determination unit 92 does not need to be provided. when the moving object 9 has satisfied the predetermined condition. The request determination unit 92 may perform the operation only by depression of the emergency switch 99.

“Another Example 1 of the Trigger Step S61 (Emergency Signal Transmission Instruction)”

Instead of using the emergency switch 99 as a trigger, the operations from step S62 to S67 in FIG. 4 may be performed when the communication unit 95 receives an emergency signal transmission instruction, which instructs to “transmit the emergency signal”, from another wireless communication device. When the transmission instruction of the emergency signal is set to the trigger, this trigger is effective in the following cases:
1. a case where the operator of the moving object 9 cannot depress the emergency switch 99 due to an injury, a syncope, or binding of arms and legs of himself;
2. a case where the operator of the moving object 9 himself is a wanderer, a fugitive, or an amnesiac, so that the operator has no intention of depressing the emergency switch 99; and
3. a case where the operator of the moving object 9 has left the moving object 9, the moving object 9 has been seized, or the operator is physically separated from the moving object 9.

Specific examples are as follows:

When an unconscious person, a missing person, or a wandering elderly person is made to carry the moving object 9, for example, the location of the unconscious person, the missing person, or the wandering elderly person may be image-captured.

When the moving object 9 is mounted on a vehicle or an airplane and when a distress, an accident, or a theft occurs, the site of the distress, the site of the accident, or a stolen car may be image-captured as long as the mounted moving object 9 normally operates.

### “Another Example 2 of Trigger Step S61 (Abnormal Values of Various Sensors)”

When the moving object 9 includes the temperature sensor and the temperature sensor detects an abnormally high temperature or when the moving object 9 is equipped with the vibration sensor and the vibration sensor detects an earthquake and a shock, the operations in steps S62 to S67 in FIG. 4 may be performed, instead of using the emergency switch 99 as the trigger. It may also be so arranged that the moving object 9 includes various other sensors such as an audio sensor, a pressure sensor, an optical sensor, an atmospheric pressure sensor, or an altitude sensor and the operations in steps S62 to S67 in FIG. 4 are performed when the sensor observe abnormal values.

### “Explanation of Method of Capturing Image of Moving Object Using Ground Computer 13 of Ground Station Apparatus 12”

FIG. 5 is a diagram showing an example of a process operation of the ground computer 13 of the ground station apparatus 12 in the moving object image capture system 100 in the first embodiment.

### “S71: Image Capture Request Reception Step”

The image capture instruction unit 31 of the ground computer 13 receives the image capture request signal 83 from the moving object 9. The image capture instruction unit 31 stores a reception time of the image capture request signal 83 in a storage device 19. The image capture instruction unit 31 transfers the image capture request signal 83 to the image synthesis unit 32.

As described above, the image capture request signal 83 includes the following information:
1. the identification information on the moving object 9;
2. the coordinate position 81 of the moving object 9;
3. the transfer destination information 74 on the transfer destination device 29;
4. the transmission time of and the transmission number for the image capture request signal 83;
5. the emergency level; and
6. the telegraphic text message or the audio message from the operator of moving object, if any.

### “S72: Image Capture Instruction Step”

The image capture instruction unit 31 searches the flying vehicle database 16 so as to select the flying vehicle 1 passing through the sky above the coordinate position 81 of the moving object 9.

The flying vehicle database 16 stores the operation information on and operation routes of the flying vehicles 1 of the different types. The image capture instruction unit 31 obtains or calculates flight routes and satellite orbits from the operation information on the flying vehicles 1. Then, the image capture instruction unit 31 determines whether or not the flying vehicle 1 passing through the sky above the coordinate position 81 of the moving object 9 is present. When it is determined that a plurality of the flying vehicles 1 are present, at least one flying vehicle 1 is selected based on the following standard:

1. the flying vehicle 1 capable of image-capturing the coordinate position 81 of the moving object 9 in a shortest time, or the flying vehicle 1 passing through the sky above the coordinate position 81 of the moving object 9 the earliest;
2. the flying vehicle 1 having the camera that has a higher resolution than the flying vehicle 1 selected in the above item 1; and
3. the flying vehicle 1 passing through the route that is more perpendicular to the earth surface than the flying vehicle 1 selected in the above item 1 or 2.

Preferably, the image capture instruction unit 31 specifies a plurality of the flying vehicles 1 having different image capture specifications of the cameras 2 in order to obtain more information. The image capture specifications of each camera 2 are as follows:
1. type of the camera 2 (still picture camera or motion picture camera);
2. model of the camera 2 (image camera, infrared camera, or imaging radar);
3. resolution of the camera 2;
4. image capture range of the camera 2; and
5. image capture system of the camera 2 (image motion control (IMC) image capture system or time delay integration (TDI) image capture system).

When the imaging radar is used as the camera 2, a moving object and a region around the moving object under cloudy weather may be image-captured.

When the infrared sensor is used as the camera 2, detection of a temperature difference is facilitated. Accordingly, discovery of an accident airplane or an accident ship is facilitated.

The image capture instruction unit 31 may determine the type of each flying vehicle 1 and the number of the flying vehicles 1 according to the emergency level. When the emergency level is high, image capture should be instructed to all the flying vehicles 1. When the emergency level is low, one flying vehicle 1 should be specified.

When the information on the cause of transmitting the image capture request signal 83 is included in the image capture request signal 83, the image capture instruction unit 31 analyzes content of the image capture request signal 83 and the information on the cause of transmitting the image capture request signal 83, identifies or predicts the type of the moving object 9, the location of the moving object 9, and the cause. The image capture instruction unit 31 determines the type and the number of the flying vehicles 1 suited to the type of the moving object 9, the location of the moving object 9, and the cause of transmitting the image capture request signal 83.

When the type of the moving object 9 is a radio device of a ship on the sea, for example, the image capture instruction unit 31 selects a stationary satellite. When the type of the moving object 9 is a cellular phone owned by an individual, the image capture instruction unit 31 selects a quasi-zenith satellite or an information search satellite.

When the position of the moving object 9 is on the sea or a flatland, the image capture instruction unit 31 selects a stationary satellite. When the position of the moving object 9 is in a city or an urban area, the image capture instruction unit 31 selects a quasi-zenith satellite or an information search satellite.

When the image capture request signal 83 is transmitted from an individual, the image capture instruction unit 31 selects the flying vehicle 1 mounting the camera 2 having a high resolution. When the image capture request signal 83 is transmitted from a ship or an airplane, the image capture instruction unit 31 selects the flying vehicle 1 mounting the camera 2 having a resolution of an intermediate or higher level. When the image capture request signal 83 is transmitted from a construction or a facility, the image capture instruction unit 31 selects the flying vehicle 1 mounting the camera 2 having a resolution of a low level or more.

When the image capture request signal 83 is transmitted from the moving object 9 for detecting an earthquake or a Tsunami, the image capture instruction unit 31 selects the flying vehicle 1 for image-capturing a wide region. When the image capture request signal 83 is transmitted from the moving object 9 for detecting a fire or an accident, the image capture instruction unit 31 selects the flying vehicle 1 for image-capturing a medium region or a region wider than the medium region. When the image capture request signal 83 is transmitted from an individual, the image capture instruction unit 31 selects the flying vehicle 1 for image-capturing a narrow region or a region wider than the narrow region.

When at least one of the flight speed, the flight route, the flight position, the flight altitude, and the flight attitude of the flying vehicle 1 may be changed, the image capture instruction unit 31 prepares instruction data on the change of the flight speed, the flight route, the flight position, the flight altitude, or the flight attitude of the flying vehicle 1 so that the coordinate position 81 of the moving object 9 may be image-captured better.

When at least one of the resolution, the view angle, the zoom factor, the image capture time interval, the number of images to be captured, and the view field direction of the camera 2 may be changed, the image capture instruction unit 31 prepares instruction data on the change of the resolution, the view angle, the zoom factor, the image capture time interval, the number of images to be captured, or the view field direction of the camera 2 so that image capture may be performed better.

The image capture instruction unit 31 transmits the image capture instruction signal 71 to the selected flying vehicle 1. The image capture instruction signal 71 includes the following instruction data:
1. the coordinate position 81 of the moving object 9 to be image-captured;
2. the instruction data on the change of at least one of the flight speed, the flight route, the flight position, the flight altitude, and the flight attitude;
3. the instruction data on the change of at least one of the resolution, the view angle, the zoom factor, the image capture time interval, the number of images to be captured, and the view field direction; and
4. the number of images to be captured and the image capture time interval.

The image capture instruction unit 31 outputs the transfer destination information 74 (for example, the identification information on and the address of the transfer destination device 29) on the transfer destination device 29 included in the image capture instruction signal 71 to the transfer unit 33.

As position information, information on the coordinate position may be employed, or information using a description by latitude and longitude may be employed. These information correspond in a one-to-one relationship as the position information. Even if the coordinate system uses different description and the different description form, these information may be converted to a coordinate position in a specific coordinate system by a specific coordinate conversion process. These information is converted and calculated as the coordinate position, using a geodetic coordinate system such as the WGS84 adopted by the navigation satellites, and is transmitted to the on-board computer 8.

The on-board computer 8 of the flying vehicle 1 receives the image capture instruction signal 71. The on-board computer 8 controls each unit of the flying vehicle 1, based on the instruction data of the image capture instruction signal 71.

As described in FIGS. 2 and 3, the on-board computer 8 analyzes a necessary attitude change amount for causing the sight line 11 of the camera to point to the moving object 9 and operates the attitude control actuator 6. Consequently, the attitude of the flying vehicle 1 is changed, so that the sight line 11 of the camera is controlled to point to the moving object 9. That is, the on-board computer 8 changes the attitude of the flying vehicle 1 detected by the attitude sensor 5, by the attitude control actuator 6, based on the instruction data of the image capture instruction signal 71.

Alternatively, the on-board computer 8 changes the sight line 11 of a sight line camera of the camera 2 by the view direction change device 7 so as to change the view field direction.

Then, the on-board computer 8 uses the camera 2 to capture the image of the earth surface, based on the instruction data of the image capture instruction signal 71 when the flying vehicle 1 passes through the sky above the coordinate position 81 of the moving object 9. The camera 2 outputs to the on-board computer 8 the imagery data 72 obtained by the image-taking. The on-board computer 8 wirelessly transmits the imagery data 72 to the ground computer 13 of the ground station apparatus 12.

The on-board computer 8 may capture the image as instructed by the image capture instruction signal 71. However, even if the instruction is not given by the image capture instruction signal 71, the on-board computer 8 may automatically capture as follows and transmit a plurality of images as the imagery data 72.
1. the plurality of images taken at predetermined time intervals;
2. the plurality of images taken at different angles (different orbit positions) with respect to a direction of the earth;
3. the plurality of images taken using different resolutions when the resolutions may be changed;
4. the plurality of images taken with an enlarged or shrunk view field range when the view field range may be varied;
5. the plurality of images taken in different flight directions when the flight directions may be changed;
6. the plurality of images taken at different flight altitudes when the flight altitudes may be changed; or
7. the plurality of images taken by automatically changing, at the flying vehicle 1, the function of the flying vehicle 1 or the function of the camera 2, other than the use of the attitude control actuator 6.

As described above, by image capture of the plurality of images having different specifications by the on-board computer 8 on its own initiative in response to one image capture instruction signal 71, a detailed state of the moving object 9 may be found even if there is no detailed instruction from the ground station apparatus 12.

### “S73: Imagery Data Reception Step”

The image synthesis unit 32 of the ground computer 13 receives the imagery data 72. The image synthesis unit 32 stores the imagery data 72, the image capture range of the imagery data, and the reception year, month, date, and time of the imagery data 72 in the image database 17. The image synthesis unit 32 marks the imagery data 72 with a circle or an arrow so that the location of the coordinate position 81 of the moving object 9 may be visually recognized.

When the received imagery data 72 is the image corresponding to the repeated transmission instruction 82, shown in FIG. 4, for a second time or a third time, it means that the moving object 9 has moved. In this case, the position of the moving object 9 corresponding to the transmission instruction 82 for a first time is marked with a circle or an arrow in the imagery data 72, and the movement trail of the moving object 9 is recorded with a line segment in the imagery data 72.

### “S74: Map Information Synthesis Step”

The image synthesis unit 32 retrieves the map information corresponding to the imagery data from map data of the map database 14. Using the coordinate position 81 (such as the coordinate position (X1, Y1, Z1)) of the moving object 9 as the key, the image synthesis unit 32 retrieves information on a map and geography in which the coordinate position (X1, Y1, Z1) is located. Then, the image synthesis unit 32 selects the map information and the geographic information covering the range of the imagery data. As the map information and the geographic information, the image synthesis unit 32 uses geographic spatial information of the geographic information system (GIS), for example. The geographic spatial information includes information on a land-use map, a geological map, a city planning map, and a topographical map, geographic name information, ledger information, statistical information, information on an aerial photograph, a satellite image, and the like.

The image synthesis unit 32 synthesizes the imagery data 72 and the selected map information to generate the synthesized image information 73. Synthesis herein means converting two individual pieces of information to one piece of information so that the two individual pieces of information may be displayed on one display screen.

As a method of synthesizing the imagery data 72 and the map information, one of the following processes may be employed:

1. a process wherein the imagery data 72 and the map information are overlaid so that locations having same coordinates in the imagery data 72 and the map information overlap. When the imagery data 72 and the map information are displayed in a translucent state, both pieces of the information may be visually recognized;
2. a process wherein the imagery data 72 and the map information are disposed in up and down direction, in right and left direction, or in time series, to allow comparison; and
3. a process wherein, when the imagery data 72 is partially unclear or partially covered with a cloud or an obstacle, only the unclear portion is compensated for by the map information.

The imagery data 72 and the map information are synthesized because, when only the image is used, information on land use, geology, a city, topography, and the like is in short supply.

Further, the synthesis is made so as to provide more information in the following cases:
1. the imagery data 72 is unclear due to a bad weather;
2. since the earth surface is covered with a cloud, the earth surface cannot be taken in to the imagery data 72; or
3. the camera is a radar rather than an optical camera.

### “S75: Recorded Information Synthesis Step”

The image synthesis unit 32 retrieves from the image database 17 a recorded image in which the coordinate position (X1, Y1, Z1) is located, using the coordinate position 81 (the coordinate position (X1, Y1, Z1), for example) of the moving object 9 as the key, and selects the imagery data 72 obtained by taking an image of the coordinate position 81. That is, the image synthesis unit 32 selects the past imagery data 72 corresponding to the imagery data 72, from the recorded images of the image database 17, and the image synthesis unit 32 synthesizes the imagery data 72 and the recorded image, and generates the synthesized image information 73.

A method of synthesizing the imagery data 72 and the recorded image may also be similar to the method of synthesizing the imagery data 72 and the map information.

Among the recorded images are the recorded image taken before the emergency switch 99 is depressed (the recorded image where the moving object 9 that has transmitted the image capture request signal 83 was not taken therein) and the recorded image taken after the emergency switch 99 has been depressed (the recorded image where the moving object 9 that has transmitted the image capture request signal 83 was taken therein).

When the transmission number is one, the image synthesis unit 32 searches whether or not there is the recorded image which has been taken before the emergency switch 99 is depressed (the recorded image where the moving object 9 that has transmitted the image capture request signal 83 was not taken therein). Then, the image synthesis unit 32 synthesizes the recorded image taken before the emergency switch 99 is depressed with the imagery data 72 and provides a synthesized image. In this case, comparison may be made between the image before the moving object 9 is present and the current image in which the moving object 9 is present. A change in an on-the-spot situation may be confirmed by comparison between the normal time and the emergency time.

When the transmission number is two or more, the image synthesis unit 32 synthesizes the recorded images after the emergency switch 99 has been depressed with the imagery data 72, and provides a synthesized image. In this case, comparison may be made between the current image in which the moving object 9 is present and the recorded images taken until the last recorded image after the moving object 9 has depressed the emergency switch 99. A latest change in the on-the-spot situation may be visually confirmed from time to time.

The ground computer 13 may receive the imagery data 72 from a plurality of the flying vehicles 1. Alternatively, the ground computer 13 may receive a plurality of the imagery data 72 from one flying vehicle 1. When the plurality of the imagery data 72 are received in response to the same transmission number as described above, the plurality of the imagery data 72 are synthesized. A method of synthesizing the plurality of imagery data 72 may also be similar to the method of synthesizing the imagery data 72 and the map information.

The map information synthesis step S74 and the recorded information synthesis step S75 are arbitrary processes. Accordingly, followings are examples of the synthesized image information 73 (in which “+” provided below means synthesis):
1. synthesized image information 73=imagery data 72 (when the imagery data 72 is the synthesized image information 73 on the synthesized image information without alteration);
2. synthesized image Information 73=imagery data 72+map information;
3. synthesized image information 73=imagery data 72+recorded image;
4. synthesized image information 73=imagery data 72+map information+recorded image;
5. synthesized image information 73=a plurality of imagery data 72;
6. synthesized image information 73=a plurality of imagery data+map information;
7. synthesized image information 73=a plurality of imagery data 72+recorded image; and
8. synthesized image information 73=a plurality of imagery data 72+map information+recorded image.

A plurality of pieces of map information may be synthesized, and a plurality of recorded images may be synthesized.

The image synthesis unit 32 outputs the synthesized image information 73 to the transfer unit 33.

### “S76: Transfer Step”

The transfer unit 33 receives the synthesized image information 73 from the image synthesis unit 32.

The transfer unit 33 receives the transfer destination information 74 from the image capture instruction unit 31. The transfer unit 33 generates the transfer image information 75 including the imagery data 72 received from the flying vehicle 1. The transfer image information 75 includes the following information:
1. the identification information on the moving object 9;
2. the coordinate position 81 of the moving object 9;
3. the synthesized image information 73;
4. the reception time of and a reception number for the image capture request signal 83;
5. a reception time of the imagery data 72; and
6. the audio information or the character information.

The transfer unit 33 transmits the transfer image information 75 to the moving object 9 and the transfer destination device 29. The transfer destination device 29 may be more than one, and the transfer unit 33 transfers the transfer image information 75 to the plurality of the transfer destination devices 29.

The moving object 9 displays the transfer image information 75 on the display screen 94. The request determination unit 92 of the moving object 9 receives the transfer image information 75, calculates a place of the imagery data 72 where the current position of the moving object 9 is located, and determines whether or not to output the subsequent transmission instruction 82.

### 1. Emergency Response System

As an implementation of the system in this embodiment, an emergency response system will be explained.

### “Emergency Switch”

FIG. 6 shows a case where the moving object 9 is a cellular phone handset 98.

### (1) Configuration

The cellular phone handset 98 in FIG. 6 has the moving object receiving unit 91, the display screen 94, and the emergency switch 99. When the emergency switch 99 is depressed at a time of emergency, the cellular phone handset 98 transmits the image capture request signal 83.

The image capture request signal 83 functions as emergency information.

Content of this emergency information includes:

⊚ owner information (name, cellular phone number, and others);

⊚ self-position information (GPS coordinates); and

⊚ image capture instruction command

### (2) Function

The owner of the cellular phone handset 98 operates the emergency switch 99 at the time of emergency such as a disaster, an accident, or an incident. The ground station apparatus 12 performs the following emergency operations:

⊚ The ground station apparatus 12 transmits an alarm to the transfer destination device 29 installed in an emergency response organization such as a police, a security organization, or an emergency unit. The ground station apparatus 12 transmits the owner information in particular.

⊚ The ground station apparatus 12 sends the image capture instruction signal 71 to a satellite to instruct emergency image capture. In that case, the image capture instruction signal 71 includes the coordinate position of the cellular phone handset and an image capture command.

### (3) System Operation

⊚ A manager of the emergency response organization who has received the alarm makes a phone call to the cellular phone handset 98 for confirmation.

⋆ When the situation becomes clear by the phone call between the manager and the owner of the cellular phone handset, the manager of the emergency response organization handles the situation according to the situation.

⋆ When there is no reaction for the phone call of the confirmation, the manager of the emergency response operation copes with the emergency. That is, the ground station apparatus 12 instructs the camera 2 of the flying vehicle 1 to perform emergency image capture.

⋆ When it is determined from the phone call between the manger and the owner of the cellular phone handset that the depression of the emergency switch 99 is an error and the emergency information is a false alarm, the manager cancels the emergency information.

The functions, the operations, the effects of the cellular phone handset 98, the ground station apparatus 12, and the transfer destination device 29 are as described above.

### (4) Effects of Emergency Response System

⊚ In the case of a large-scale disaster, the scale and the range of the disaster are clarified according to whether emergency calls simultaneously occur, whether the emergency calls occur from a same region, and whether the emergency calls occur in multiples. Assume that autonomous operation is performed so that an observation range covers candidate points for image capture in a same region from which the emergency calls simultaneously occur. As the result, there is an advantage that a disaster range may be covered.

⊚ In the case of a fire, a spread area of the fire may be early grasped.

⊚ In the case of an accident of an airplane or a ship, an on-the-spot situation may be early grasped.

⊚ The system may cope with an incident of a moving object such as a taxicab robbery.

⊚ The system may cope with a kidnapping case or the like where a criminal and a victim change their positions in real time.

⊚ Since an on-the-spot situation may be visually imaged, deployment of a police, a firefighting unit, an emergency unit, a rescue unit, or the like and determination about a traveling route may be promptly and readily made.

⊚ Even under a situation where information cannot be communicated by a phone call in a near-death situation, a kidnapping case, or a burglary case, necessary information and an emergency level may be communicated.

### 2. Wandering Elderly Person Support System

As an implementation of the system in this embodiment, a wandering elderly person support system will be explained.

FIG. 7 shows a case where the moving object 9 is the cellular phone handset 98, which is constituted from a family-side base unit 96 and an elderly-person-side cordless handset 97.

### (1) Configuration

The moving object 9 of this wandering elderly person support system is constituted from the family-side base unit 96 with an emergency switch and the elderly-person-side cordless handset 97 with a self-position transmitter.

### (2) Operation

A wandering elderly person carries the elderly-person-side cordless handset 97, and the elderly-person-side cordless handset 97 constantly transmits self-position information on the-elderly-person-side cordless handset 97. The family-side base unit 96 constantly receives the self-position information on the-elderly-person-side cordless handset 97.

When a family carries the family-side base unit 96 and the elderly person has been missing, the family-side base unit 96 operates the emergency switch 99 of the family-side base unit 96. When the family-side base unit 96 operates the emergency switch 99, the family-side base unit 96 transmits the image capture request signal 83, using the self-position information on the elderly-person-side cordless handset 97.

The image capture request signal 83 functions as emergency information.

Content of this emergency information includes:

⊚ information on the elderly person (name, cellular phone number, and the others);

⊚ self-position information (GPS coordinates) on the-elderly-person-side cordless handset 97;

⊚ image capture instruction command; and the like.

Functions and operations of the family-side base unit 96, the ground station apparatus 12, and the transfer destination device 29 are as described above.

When the family-side base unit 96 operates the emergency switch 99, the elderly-person-side cordless handset 97 may transmit the image capture request signal 83, using the self-position information on the elderly-person-side cordless handset 97, as described in the “Another Example 1 (Emergency Signal Transmission Instruction) of Trigger Step S61”.

The wandering elderly person support system may also be used for searching a stray child, a missing person, a distressed person, and the like.

As described above, in the first embodiment, the moving object image capture system 100 was described in which the observation satellite (flying vehicle 1) having pointing means constituted from the attitude control actuator 6 and the view direction change device 7 which point to the coordinate position 81 of an earth fixed coordinate system adopted by the navigation satellites 3, and image capture means constituted from the camera 2. The observation satellite (flying vehicle 1) obtains from the ground station apparatus 12 the coordinate position of the moving object 9 measured by the navigation satellites 3, and image capture is performed pointing to the coordinate position 81.

The moving object image capture system 100 in the first embodiment is characterized as follows:

1: the self-locating position (coordinate position 81) of the moving object 9, together with the image capture request signal 83, are transmitted from the moving object 9 to the ground station apparatus 12 (relay station) as a specified image-taking position;
2: the ground station apparatus (relay station) 12 selects one of the plurality of the satellites (flying vehicles 1) each mounting the camera capable of taking an image of the specified image-taking position, based on the image capture request signal 83 and transmits an image-taking instruction and the image-taking position to the selected satellite (flying vehicle 1) mounting the camera; and
3: upon reception of the image-taking instruction, the selected satellite (flying vehicle 1) mounting the camera takes an image of a location of the image-taking position.

In this first embodiment, the moving object 9 is furnished to use for a moving entity such as a space vehicle, a marine vehicle, a land moving object, or a human. The moving object 9 is provided with the moving object receiving unit 91 for receiving signals from the navigation satellites 3, and transmits self-position information to the observation satellites. As transmission means, command transmission is performed via the ground station apparatus 12 which takes in charge of tracking control over the observation satellites.

According to this first embodiment, a monitor image of the moving object 9 and a location image of the vicinity of the moving object 9 may be obtained. When a stationary satellite is used as the observation satellite, constant monitoring may be performed. When an earth orbiting satellite is used as the observation satellite, monitoring with a high-resolution and high image quality is possible. Then, by increasing the number of the observation satellites to be adopted, updating of data with a high frequency becomes possible.

When the moving object 9 is an airplane, the airplane may grasp a meteorological situation in the vicinity of the airplane such as a cloud distribution.

When the moving object 9 is a vehicle, the vehicle may grasp a traffic jam situation in the vicinity of the vehicle.

When the moving object 9 periodically transmits position information, and when the ground station apparatus 12 is provided with means for periodically recording the position information, a monitor image on the spot of an accident may be obtained, using the recorded position information up to signal disconnection from a crashed airplane or a sunken ship.

### Second Embodiment

FIG. 8 is a configuration diagram of a moving object image capture system 100 showing a second embodiment of the present invention.

A difference from the moving object image capture system 100 in the first embodiment will be described below.

### (1) System Configuration

The moving object image capture system 100 in the second embodiment is constituted from a moving object 9, a ground station apparatus 12, an observation satellite 86, and a communication satellite 87. The observation satellite 86 is an example of a flying vehicle 1.

By using an artificial satellite as the flying vehicle 1, any region on the entire earth may be monitored.

### (2) System Operation

The moving object image capture system 100 in the second embodiment transmits and receives an image capture request signal 83 from the moving object 9 such as a cellular phone via the communication satellite 87. A stationary satellite may be used as the communication satellite 87.

In the second embodiment, the communication satellite 87 includes information transmission and reception means for transmitting position information to the observation satellite 86 from the communication satellite 87. The communication satellite 87 transfers the image capture request signal 83 to the observation satellite 86. In that case, the observation satellite 86 performs an image capture operation based on the image capture request signal 83.

The communication satellite 87 may generate an image capture instruction signal 71 from the image capture request signal 83, and may transmit the image capture instruction signal 71 to the observation satellite 86.

Alternatively, the communication satellite 87 may include information transmission and reception means for transmitting the position information to the ground station apparatus 12 from the communication satellite 87, and the communication satellite 87 may transfer the image capture request signal 83 to the ground station apparatus 12.

The other functions and operations are the same as those in the moving object image capture system 100 in the first embodiment.

As described above, the moving object image capture system 100 in the second embodiment is constituted from the observation satellite 86 including pointing means for pointing to a coordinate position of an earth fixed coordinate system adopted by navigation satellites 3 and image capture means, and the communication satellite 87 which receives the coordinate position of the moving object 9 measured by the navigation satellites 3 to transmit the coordinate position to the observation satellite 86.

Alternatively, the moving object image capture system 100 in the second embodiment is constituted from the communication satellite 87 which receives the coordinate position of a moving object measured by the navigation satellites and transmitting the coordinate position to the ground, and the ground station apparatus 12 which receives the transmitted signal from the communication satellite 87 and transmits the coordinate position of the moving object to the observation satellite 86.

In the second embodiment, one satellite may include both of the functions of the communication satellite 87 and the observation satellite 86. In this case, there is an advantage that the need for the information transmission and reception means between the communication satellite 87 and the observation satellite 86 is eliminated.

According to the second embodiment, in addition to the same effects with those in the first embodiment, self-position information is transmitted via the communication satellite 87. Thus, even a location deep in the mountain, on the ocean, or the like where the self-position information is difficult to transmit may be accommodated. When the self-position information is automatically transmitted, image capture for monitoring becomes possible for searching the target such as a distressed airplane, an accident vehicle, a wandering elderly person, or a kidnapped victim, wherein intentional generation of an image capture instruction is difficult by the target.

### Third Embodiment

FIG. 9 is a configuration diagram of a moving object image capture system 100 showing a third embodiment of the present invention. A difference from the moving object image capture system 100 in the first embodiment will be described below.

### (1) System Configuration

The moving object image capture system 100 in the third embodiment is constituted from a moving object 9, a ground station apparatus 12, and a quasi-zenith satellite 88. The quasi-zenith satellite 88 includes at least one of functions of a navigation satellite, a communication satellite, and an observation satellite. Alternatively, the quasi-zenith satellite 88 may include all of the functions of the navigation satellite, the communication satellite, and the observation satellite.

### (2) System Operation

For example, the quasi-zenith satellite 88 of the moving object image capture system 100 in the third embodiment has the same configuration as the flying vehicle 1 in the first embodiment, and the quasi-zenith satellite 88 functions as the flying vehicle 1. The quasi-zenith satellite 88 relays an image capture request signal 83 from the moving object 9 such as a cellular phone to the ground station apparatus 12, and the quasi-zenith satellite 88 functions as a communication satellite 87. The quasi-zenith satellite 8 may also be used as one of navigation satellites 3.

The other functions and operations of the moving object image capture system 100 are the same as those of the moving object image capture system 100 in the first embodiment.

As described above, this third embodiment is characterized by using the quasi-zenith satellite 88 as the navigation satellite. Alternatively, this third embodiment is characterized in that the quasi-zenith satellite 88 includes both of navigation means and observation means. When the quasi-zenith satellite 88 functions as the communication satellite and the observation satellite, the moving object 9 uses a transmitter to directly transmit the image capture request signal 83 to the quasi-zenith satellite 88.

Alternatively, this third embodiment is characterized in that the quasi-zenith satellite 88 includes the navigation means, the observation means, and communication means. When the quasi-zenith satellite 88 functions as the observation satellite, image capture may be performed substantially from the zenith. Thus, the moving object even at a location between buildings may be monitored.

### Fourth Embodiment

FIG. 10 is a configuration diagram of a moving object image capture system 100 showing a fourth embodiment of the present invention. A difference from the moving object image capture system 100 in the first embodiment will be described below.

### (1) System Configuration

A receiving unit 84 is added to the moving object image capture system 100 in the fourth embodiment. In the moving object image capture system 100 in the fourth embodiment, the receiving unit 84 and a ground station apparatus 12 are both installed on the ground to form a ground station system.

### (2) System Operation

The receiving unit 84 of the moving object image capture system 100 in the fourth embodiment is interposed between a moving object 9 and the ground station apparatus 12, and transmits to and receives from each of the moving object 9 and the ground station apparatus 12 a signal. The receiving unit 84 directly transmits moving object information 51 to a transfer destination device 29. The moving object information 51 is information which is same information as in an image capture request signal 83 or information generated from the image capture request signal 83. Using the moving object information 51, the transfer destination device 29 transmits to and receives from the moving object 9 communication information 52.

FIG. 11 includes diagrams showing signals transmitted and received by the receiving unit 84. Referring to FIG. 11, a signal on the left of the page of FIG. 11 is a signal transmitted to and received from the moving object 9 or a communication satellite 87. A signal on the right of the page of FIG. 11 is a signal transmitted to and received from the ground station apparatus 12, a communication satellite 85, or an observation satellite 86. The receiving unit 84 includes the following functions in the cases of (a) to (f) of FIG. 11. The receiving unit 84 may include all the functions in (a) to (f), or any one of the functions in (a) to (f) may be performed by setting of a switch provided at the receiving unit 84.

In the case of (a), the receiving unit 84 includes the transfer function of the image capture request signal 83.
In the case (b), the receiving unit 84 includes the function of an image capture request transmission unit 93 of the moving object 9.
In the case (c), the receiving unit 84 includes the function of an image capture instruction unit 31 of a ground computer 13.
In the case (d), the receiving unit 84 includes the transfer function of transfer image information 75.
In the case of (e), the receiving unit 84 includes the functions of an image synthesis unit 32 and a transfer unit 33 of the ground computer 13.
In the case of (f), the receiving unit 84 includes the function of the transfer unit 33 of the ground computer 13.

When the receiving unit 84 performs only the transfer function as in (a) and (d), the receiving unit 84 functions as an amplifier or a relay. The receiving unit 84 may be therefore considered as a part of a communication network or a network.

When the receiving unit 84 includes a part of functions of the ground station apparatus 12 as in (c), (e), and (f), the receiving unit 84 may be regarded as the ground station apparatus 12 as well.

When the receiving unit 84 includes a part of functions of the moving object 9 as in (b), the receiving unit 84 may be regarded as the moving object 9 as well.

The other functions and operations are the same as those of the moving object image capture system 100 in the first embodiment.

According to this fourth embodiment, the receiving unit 84 is provided. Thus, by disposing the receiving units 84 in various places, the moving object 9 may be image-captured and monitored even when a wireless communicable range of the moving object 9 is narrow.

Preferably, the receiving unit 84 is disposed at a cellular phone base station when the moving object 9 is a cellular phone.

### Fifth Embodiment

A difference from the moving object image capture system 100 in each of the first to fourth embodiments will be described below.

The above description was given about the case where, when the moving distance of the moving object 9 is the predetermined threshold or more, the image capture request signal is output based on determination on the side of the moving object so that intermittent image-taking (image-taking for each certain distance) may be performed. As another embodiment, the moving object 9 may transmit image capture request signals 83 (each indicative of an image-taking instruction+an image-taking position) of same content in a congested manner (successively).

In transmission of the image capture request signal 83 from the moving object 9 for a first time, a ground station apparatus 12 which becomes a relay confirms that the moving object is proper, selects an observation satellite capable of taking an image of a region in the vicinity of a specified image-taking position, and makes an image-taking reservation plan. In transmission of the image capture request signals from the moving object 9 for second and third times, the ground station apparatus (relay) 12 identifies the image-taking position and an image-taking timing for an actual capturing, and sends an image-taking instruction to the selected satellite, based on the image-taking reservation plan. The observation satellite takes an image of the location of the image-taking position, based on the image-taking instruction. Transmission of the image capture request signals 83 from the moving object 9 for the first, second, and third times is performed by an image capture request transmission unit 93 of the moving object 9 at preset timings determined by this moving object image capture system 100. Transmission intervals of the image capture request signals 83 for the first, second, and third times from the moving object are reduced for a request with a high priority, for example. The ground station apparatus (relay) 12 may ignore a transmission timing which is shorter than the predetermined timing. Even if the communication for the second time fails, the ground station apparatus (relay) 12 may transmit the image-taking instruction by the communication for the third time. The number of times of transmission of the image capture request signal 83 by the moving object 9 may be four or more.

The moving object 9 transmits the image capture request signals 83 (the image-taking instruction+the image-taking position) in the congested manner. Thus, even in the case of one-way communication from the moving object 9 to the ground station apparatus (relay) 12, image-taking may be performed without fail, with the moving object 9 not receiving a response signal (ACK signal) for authentication confirmation from the ground station apparatus 12.

Since the ground station apparatus (relay) 12 makes the image-taking reservation plan, image capture reservations do not conflict, and the ground station apparatus 12 does not select an observation satellite which cannot perform image taking.

When bi-directional communication between the moving object 9 and the ground station apparatus (relay) 12 can be made, the moving object 9 may transmit the image capture request signals 83 in the congested manner until the moving object 9 receives the response signal (ACK signal) from the ground station apparatus (relay) 12.

Further, when the bi-directional communication between the moving object 9 and the ground station apparatus (relay) 12 can be performed for the first time, the image capture request signal, only with an image-taking instruction not including the image-taking position (coordinate position), may be transmitted from the moving object 9. Then, the ground station apparatus (relay) which has received the transmission for the first time from the moving object 9 may transmit an image-taking permission signal, a timing synchronization signal, and the like to the moving object 9. Then, when the moving object 9 receives the image-taking permission signal from the ground station apparatus (relay) 12, the moving object 9 may transmit the image-taking position (coordinate position) in transmission for the second time, based on the timing synchronization signal, and a positioning satellite may perform image-taking.

### Sixth Embodiment

A difference from the moving object image capture system 100 in each of the first to fifth embodiments will be described below.

In a moving object image capture system 100 in a sixth embodiment, there is no ground station apparatus 12. A flying vehicle 1 receives a distress signal rather than an image capture request signal 83 from a moving object 9, and transfers imagery data 72 to a transfer destination device 29.

A description will be given below about a case where the flying vehicle 1 is an observation satellite 86, and the transfer destination device 29 is a transfer destination device installed at a search and rescue department.

### “Configuration of Observation Satellite 86”

The observation satellite 86 in the sixth embodiment includes the following devices:

1. a radio receiver for receiving a distress signal;
2. an extraction unit for analyzing the distress signal received by the receiver to extract position information on a moving object;
3. a camera 2 for pointing to and image-capturing a coordinate position indicated by the position information on the moving object, which has been extracted by the extraction unit, thereby obtaining imagery data; and
4. a radio transmitter for transmitting the imagery data obtained by the camera 2 to the transfer destination device 29 installed at the search and rescue department;

### “Distress Signal”

The distress signal is the one transmitted by the moving object such as a ship or an airplane.

As an example of the distress signal, an emergency position indicate radio beacon (EPIRB: Emergency Position Indicate Radio Beacon) signal transmitted from a distress alarm transmitter on a ship in a GMDSS (Global Maritime Distress and Safety System) or an AIS signal transmitted from an automatic identification system (Automatic Identification System) of a ship is known. Other distress signals transmitted from the distress alarm transmitter may also be used.

### “Operation of Observation Satellite 86”

The radio receiver of the observation satellite 86 constantly monitors the distress signal transmitted from an earth surface. When the wireless receiver receives the distress signal, the wireless transmitter notifies reception of the distress signal to the extraction unit. An operation of the extraction unit of the observation satellite 86 may be implemented by hardware and software of an on-board computer 8, for example.

The EPIRB signal of the GMDSS is a beacon signal automatically transmitted from the distress alarm transmitter separated and floated from a ship when the ship is sunk. A receiving unit of the observation satellite 86 receives the beacon signal, and the extraction unit of the observation satellite 86 detects the direction in which the beacon signal has been generated and determines the position of the ship from the position of the observation satellite 86 and geographic information on the earth.

The automatic identification system of the ship needs to be constantly turned on, and continues transmitting the AIS signal of the ship even while the ship is lying. The coordinate position of the ship is included in the AIS signal. Since the AIS signal is a signal constantly transmitted in the vicinity of a port or the like, a rescue request signal separately transmitted and received is regarded as a trigger. That is, the receiving unit of the observation satellite 86 receives the distress signal constituted from the AIS signal and the rescue request signal. The extraction unit of the observation satellite 86 determines the position of the ship from the coordinate position included in the AIS signal.

The camera 2 of the observation satellite 86 points to and captures the image of the position (coordinate position) of the ship extracted by the extraction unit, thereby obtaining imagery data 72. The transmitter of the observation satellite 86 transmits the imagery data 72 obtained by the camera 2 to the transfer destination device 29 installed at the search and rescue department. The transmitter of the observation satellite 86 transfers the imagery data 72 to the transfer destination device 29 which takes in charge of search and rescue of the position (coordinate position) of the ship. The transmitter of the observation satellite 86 broadcasts the position (coordinate position) of the ship and the imagery data 72 to an earth surface as a captured signal caused by the distress signal. When the transmitter of the observation satellite 86 broadcasts the imagery data 72 to a location just below the observation satellite 86 immediately after the imagery data 72 has been obtained by image-taking, the transfer destination device 29 installed at the search and rescue department located just below the observation satellite 86 may receive the imagery data 72.

The transfer destination device 29 installed at the search and rescue department further transfers the position (coordinate position) of the ship and the imagery data 72 to an associated transfer destination device 29. The search and rescue department for an accident at sea is burden shared among all over the world. In Japan, the Maritime Safety Agency of Japan is a responsibility department.

As described above, the observation satellite 86 in the sixth embodiment is characterized by including:

the radio receiver for receiving a distress signal issued from a ship or the like;

extraction means for analyzing a signal included in the received signal to extract position information;

means for pointing to and image-capturing an extracted coordinate position; and

the radio transmitter for transmitting obtained imagery data to the search and rescue department.

According to the observation satellite 86 in the sixth embodiment, the ground station apparatus 12 becomes unnecessary. A simple system may be thereby provided.

In actual system development, all or a part of the first to sixth embodiments may be combined.

### “Explanation of Hardware”

FIG. 12 illustrates a configuration showing an example of an external view of the ground station apparatus 12 of the moving object image capture system 100 in each of the first to sixth embodiments.

Referring to FIG. 12, the ground station apparatus 12 includes hardware resources such as a system unit 910, a display device 901 including a display screen of a CRT (Cathode Ray Tube) or an LCD (of liquid crystal), a keyboard (Key board: K/B) 902, a mouse 903, an FDD (Flexible Disk Drive) 904, a compact disk drive CDD (CDD) 905, a printer device 906, and a scanner device 907. These resources are connected by cables and signal lines.

The system unit 910 is a computer, and is connected to a facsimile machine 932 and a telephone apparatus 931 by cables. The system unit 910 is also connected to an Internet 940 via a local area network LAN (LAN) 942 and a gateway 941.

FIG. 13 is a diagram showing an example of hardware resources of the ground computer 13 of the moving object image capture system 100 in each of the first to sixth embodiments.

Referring to FIG. 13, the ground computer 13 includes a CPU 911 (Central Processing Unit, which is also referred to as a central processing device, a processing unit, an arithmetic operation unit, a microprocessor, a microcomputer, or a processor). The CPU 911 is connected to a ROM 913, a RAM 914, a communication board 915, a display device 901, a keyboard 902, a mouse 903, an FDD 904, a CDD 905, a printer device 906, a scanner device 907, and a magnetic disk device 920 through a bus 912, and controls these hardware devices. A storage device such as an optical device or a memory card read/write device may be employed in place of the magnetic disk device 920.

The RAM 914 is an example of a volatile memory. Each of the ROM 913, the FDD 904, the CDD 905, and the magnetic disk device 920 is an example of a nonvolatile memory. Each of these devices is an example of the storage device or a storage unit.

Each of the communication board 915, the keyboard 902, the scanner device 907, and the FDD 904 is an example of an input unit or an input device.

Each of the communication board 915, the display device 901, and the printer device 906 is an example of an output unit or an output device.

The communication board 915 is connected to a wireless communication antenna, the facsimile machine 932, the telephone apparatus 931, the LAN 942, and the like. The communication board 915 may be connected to a WAN (world area network) such as the Internet 940 or an ISDN as well as the LAN 942. When the communication board 915 is connected to the WAN such as the Internet 940 or the ISDN, the gateway 941 becomes unnecessary.

An operating system (OS) 921, a window system 922, programs 923, and files 924 are stored in the magnetic disk device 920. Each Program of the programs 923 is executed by the CPU 911, the operating system (OS) 921, and the window system 922.

Software programs for executing the functions described as the “ - - - unit” and the “means” in the description of the first to sixth embodiments are stored in the programs 923. The programs are read and executed by the CPU 911.

The flying vehicle database 16, the map database 14, and the image database 17 are stored in the files 924. In the files 924, information described as a “determination result of - - - ”, a “computation result of - - - ”, and a “process result of - - - ”, data, signal values, variable values, and parameters are stored as respective items of “ - - - files”, and “ - - - databases”. The “ - - - files” and “ - - - databases” are stored in a storage medium such as a disk and a memory. The information, the data, the signal values, the variable values, and the parameters stored in the storage medium such as the disk and the memory are loaded into a main memory or a cache memory by the CPU 911 through a read/write circuit. Then, the information, the data, the signal values, the variable values, and the parameters that have been read are used for operations of the CPU such as extraction, retrieval, reference, comparison, arithmetic operation, computation, processing, output, printing, and display. During the operations of the CPU such as extraction, retrieval, reference, comparison, arithmetic operation, computation, processing, output, printing, and display, the information, the data, the signal values, the variable values, and the parameters are temporarily stored in the main memory, the cache memory, or a buffer memory.

An arrow portion in the flowcharts described in the first to sixth embodiments mainly indicates a data or signal input/output. The data and the signal values are recorded in recording media such as the memory of the RAM 914, the flexible disk of the FDD 904, the compact disk of the CDD 905, the magnetic disk of the magnetic disk device 920, and other optical disk, minidisk, and DVD (Digital Versatile Disk). The data and signals are on-line transmitted through the bus 912, signal lines, cables, or the other transmission media.

Each of the “ - - - unit” and the “ - - - means” described in the first to sixth embodiments may be a “ - - - circuit”, an “ - - - apparatus”, a “ - - - device”, or “ - - - means”. Alternatively, each of the “ - - - unit” and the “ - - - means” may be a “ - - - step”, a “ - - - procedure”, or a “ - - - process”. That is, the “ - - - unit” and the “ - - - means” described herein may be implemented by firmware stored in the ROM 913. Alternatively, each of the “ - - - unit” and the “ - - - means” described herein may be implemented only by software, only by hardware such as elements, devices, a substrate, or wires, or by a combination of the software and the hardware, or further, by a combination of the software and the firmware. The firmware and the software are stored in the recording media such as the magnetic disk, the flexible disk, the optical disk, the compact disk, the minidisk, and the DVD, as the programs. Each program is read from the CPU 911 and is executed by the CPU 911. That is, the program causes a computer to function as the “ - - - unit” or the “ - - - means”. Alternatively, the program causes the computer to execute the procedure or method of the “ - - - unit” or the “ - - - means”.

The transfer destination device 29 also has a system configuration shown in FIGS. 12 and 13.

Each of the on-board computer 8 and the moving object 9 also has the hardware configuration shown in FIG. 13. In the case of the on-board computer 8 and the moving object 9, a part of hardware of the hardware configuration shown in FIG. 13 may not be included according to the sizes and the functions of the on-board computer 8 and the moving object 9.

### BRIEF DESCRIPTION OF THE DRAWINGS

FIG. 1 is a configuration diagram showing a moving object image capture system according to a first embodiment;

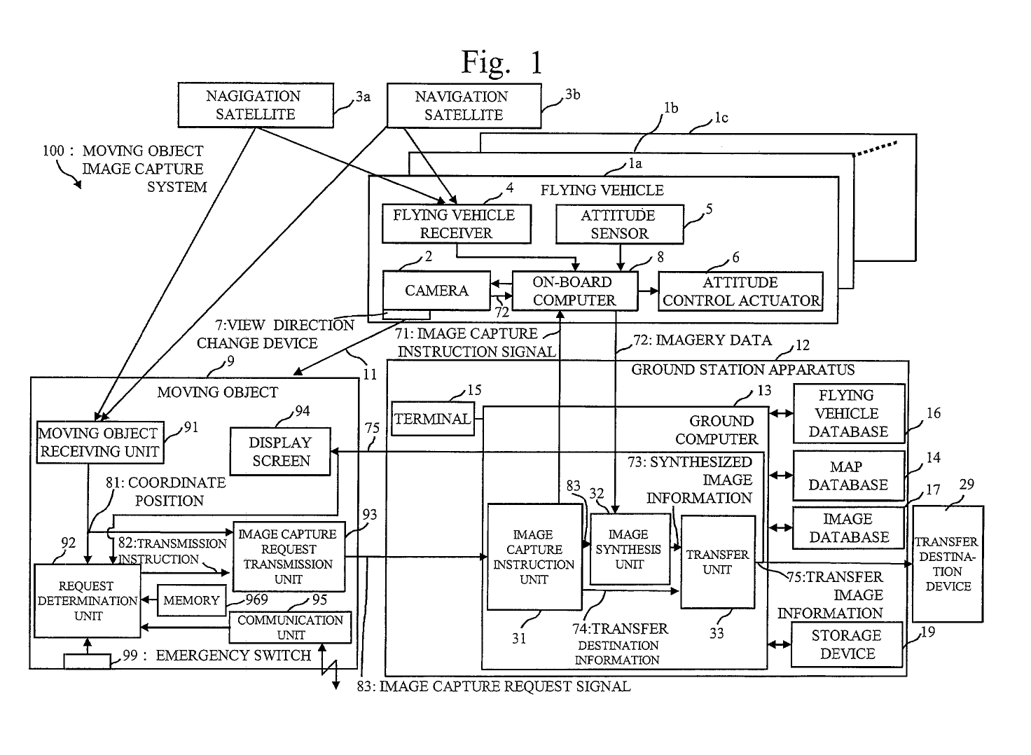

FIG. 2 is a diagram showing a method of determining an attitude change amount in the moving object image capture system according to the first embodiment, using a coordinate position as a target value;

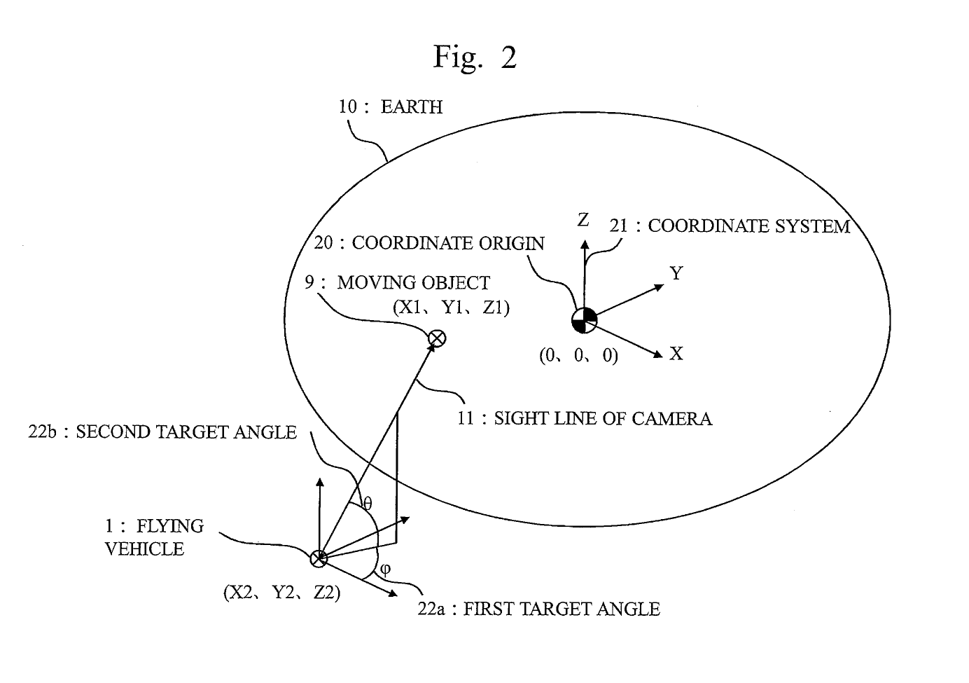

FIG. 3 is a diagram showing a process operation example of an on-board computer 8 of a flying vehicle 1 according to the first embodiment;

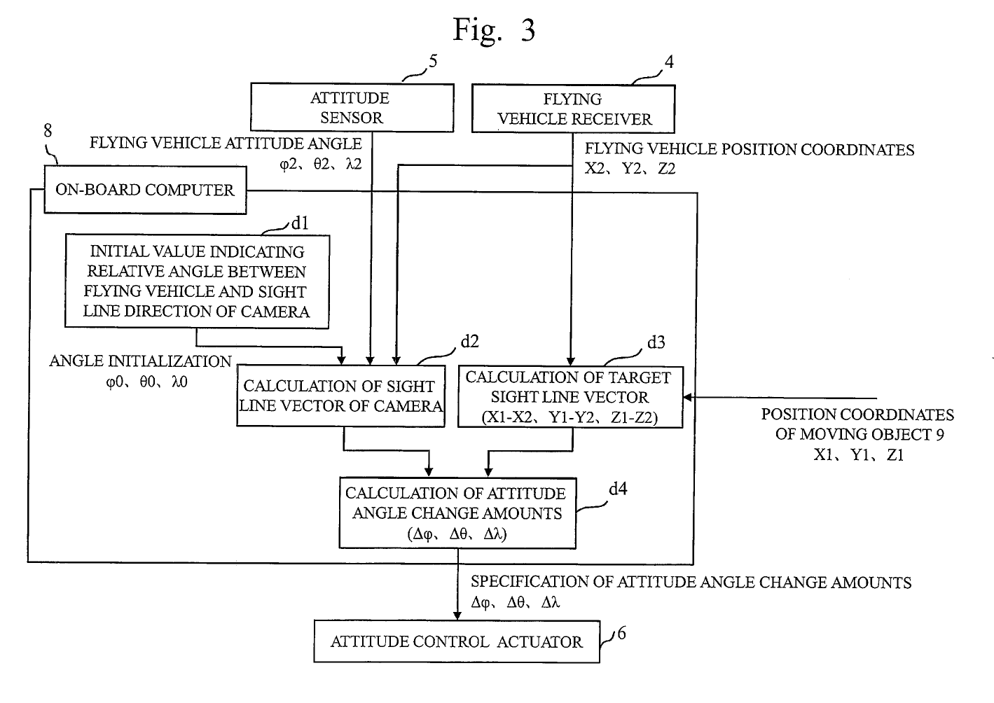

FIG. 4 is a diagram showing a process operation example of a moving object 9 in the moving object image capture system according to the first embodiment;

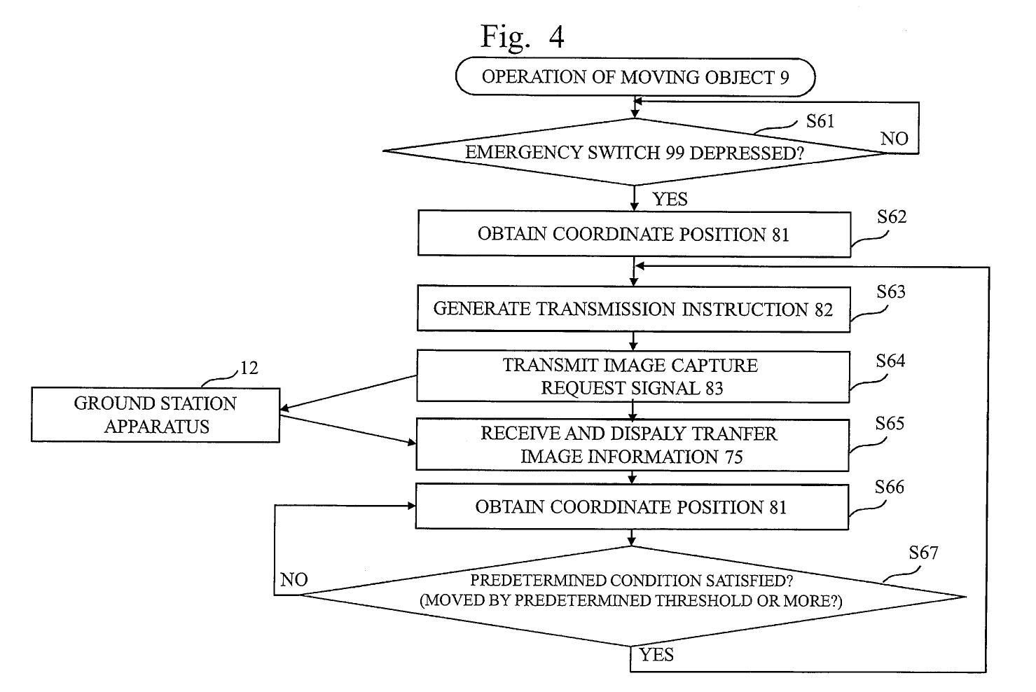

FIG. 5 is a diagram showing a process operation example of a ground computer 13 in the moving object image capture system according to the first embodiment;

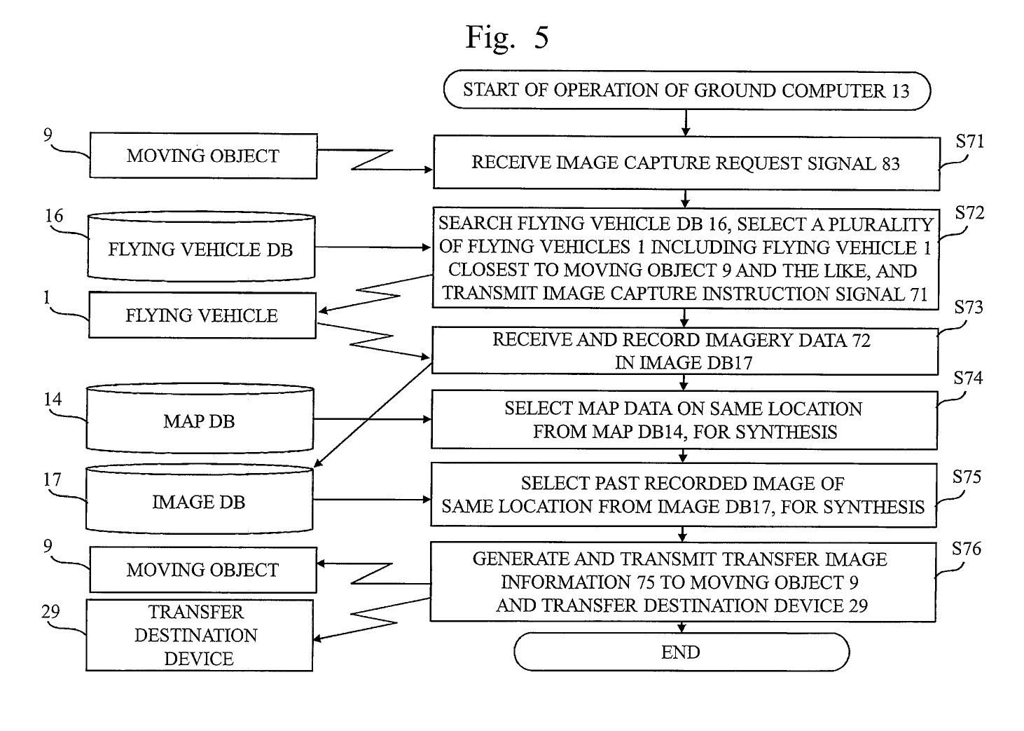

FIG. 6 shows a configuration of the moving object 9 according to the first embodiment;

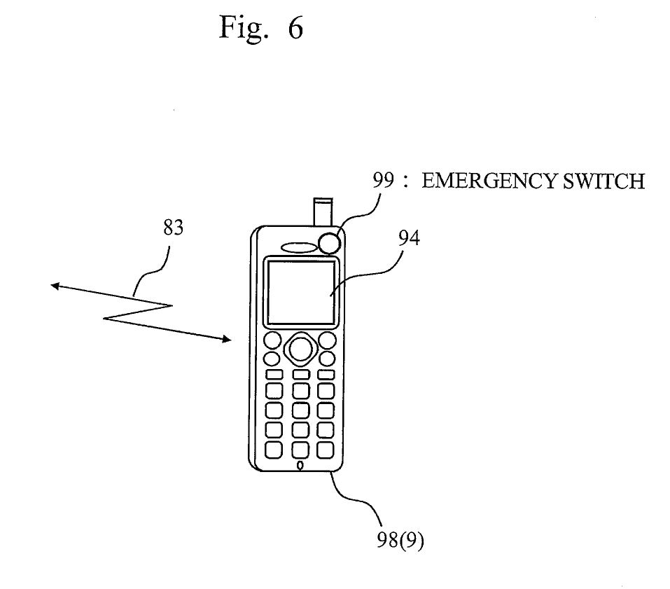

FIG. 7 shows a system configuration of the moving object 9 according to the first embodiment;

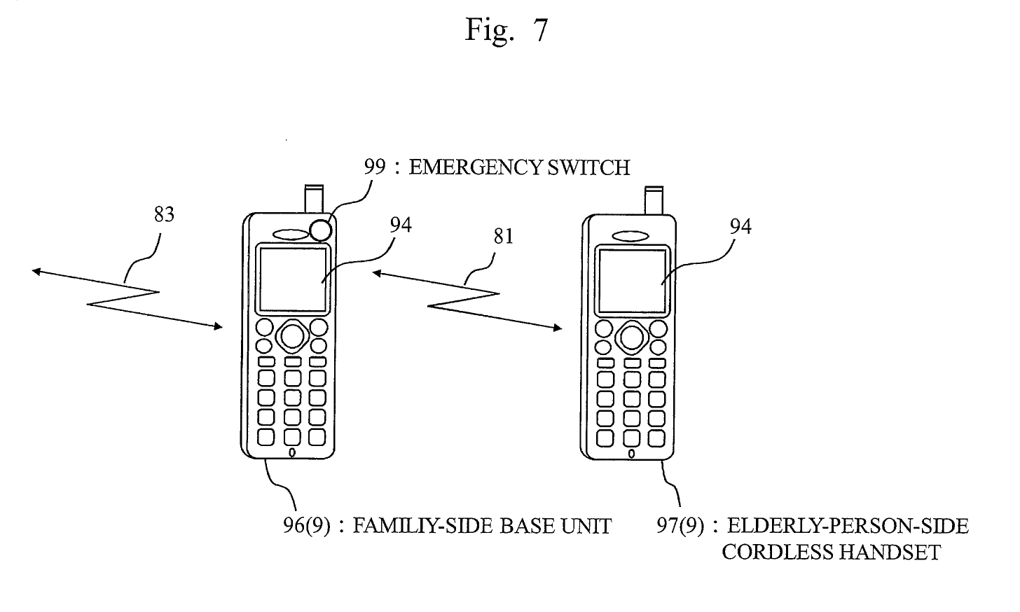

FIG. 8 illustrates a configuration showing a moving object image capture system using a communication satellite 87 according to a second embodiment;

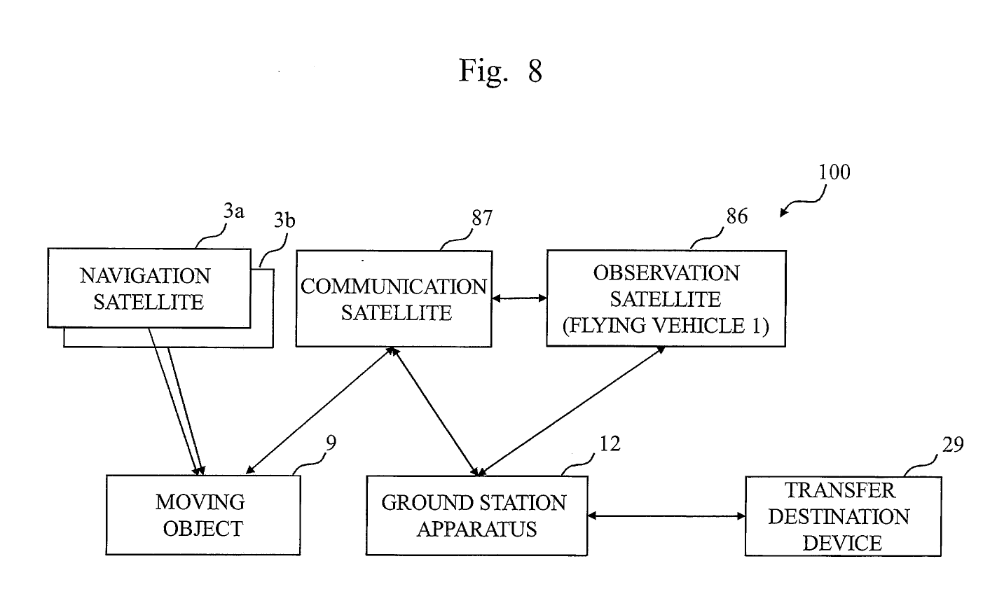

FIG. 9 illustrates a configuration showing a moving object image capture system using a quasi-zenith satellite 88 according to a third embodiment;

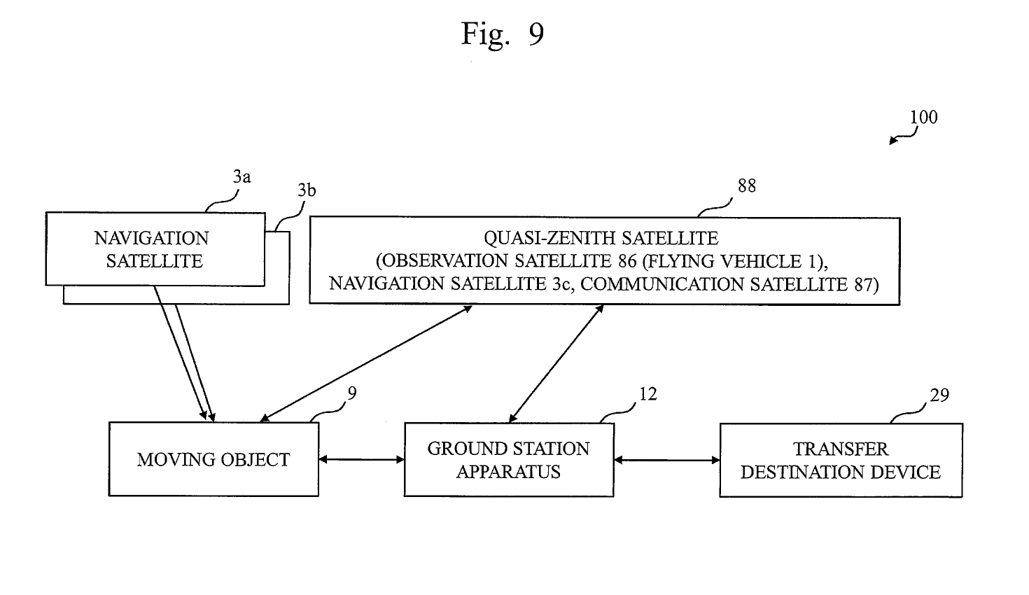

FIG. 10 illustrates a configuration showing a moving object image capture system using a receiving unit 84 according to a fourth embodiment;

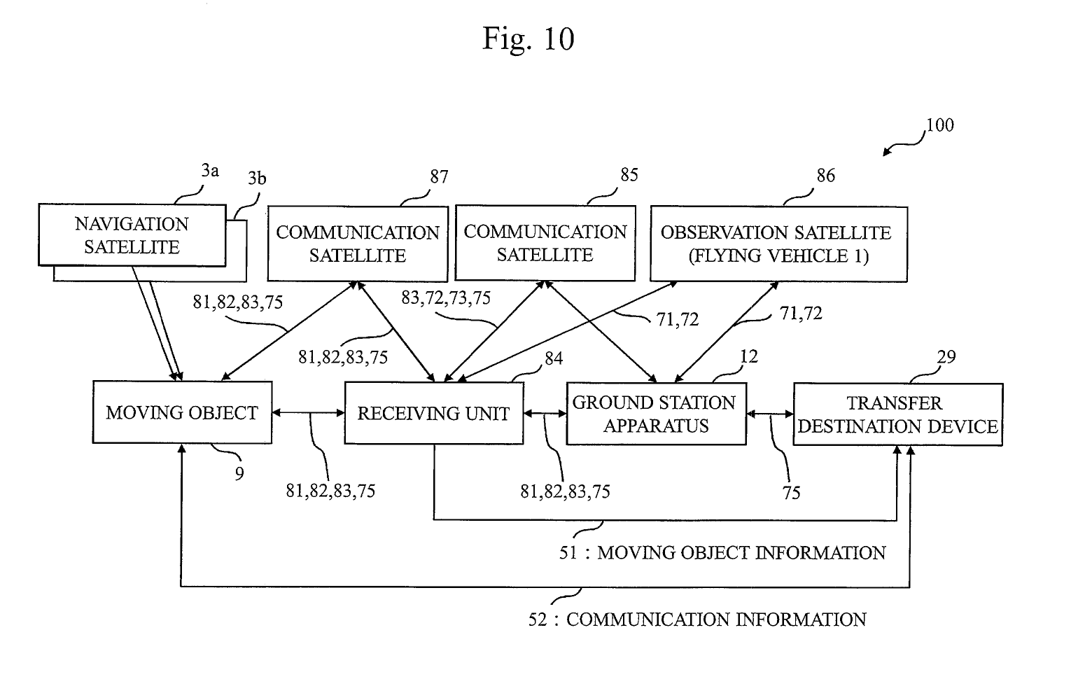

FIG. 11 is a diagram showing signals transmitted to and received from the receiving unit 84 according the fourth embodiment;

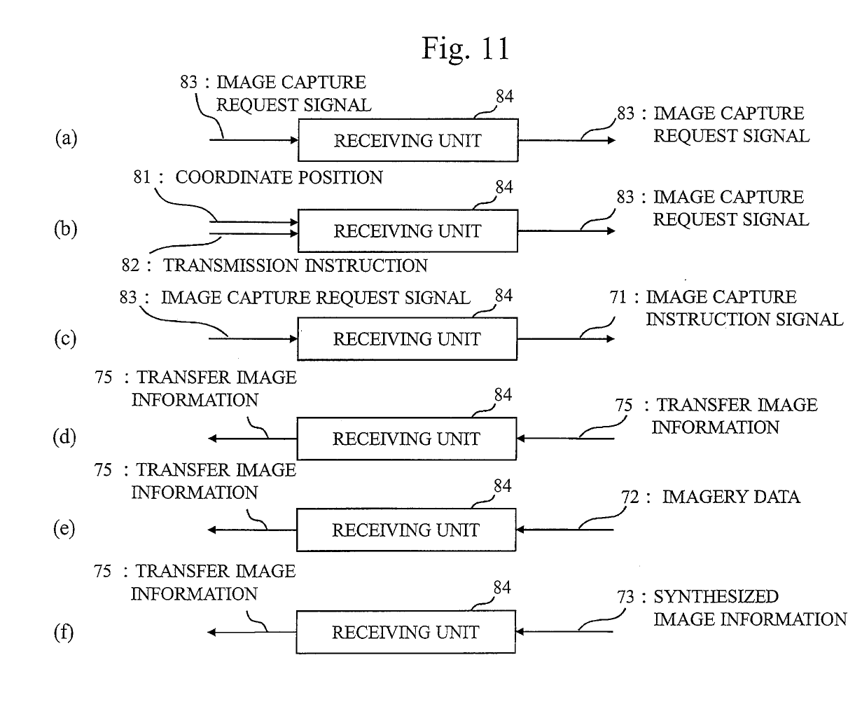

FIG. 12 is a configuration diagram showing the ground computer 13 and a transfer destination device 29 in the moving object image capture system in the first to sixth embodiments; and

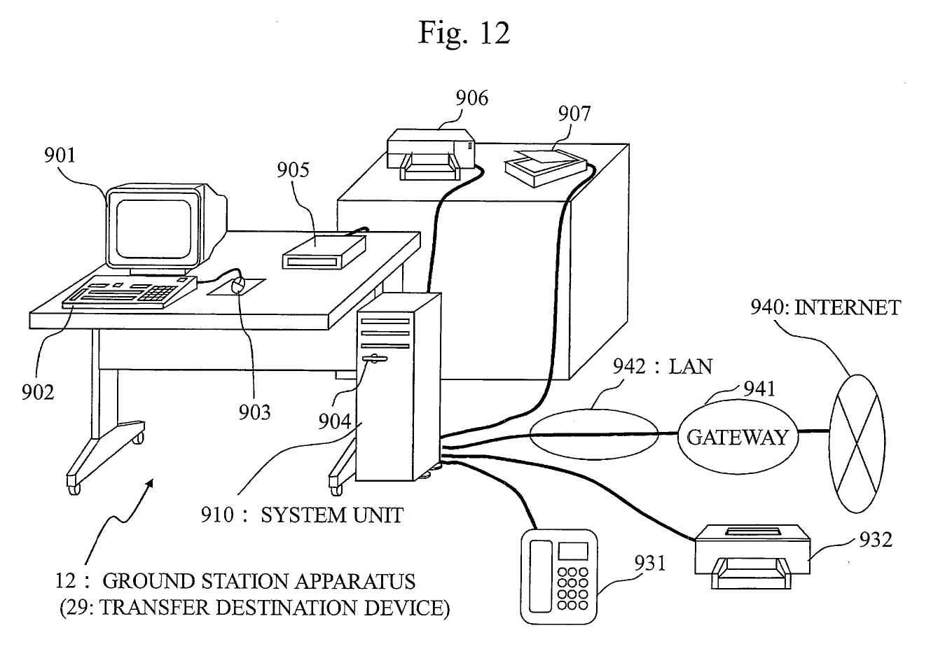

FIG. 13 is a system configuration showing the ground computer 13 of a ground station apparatus 12, the transfer destination device 29, the on-board computer 8, and the moving object 9 in the first to sixth embodiments.

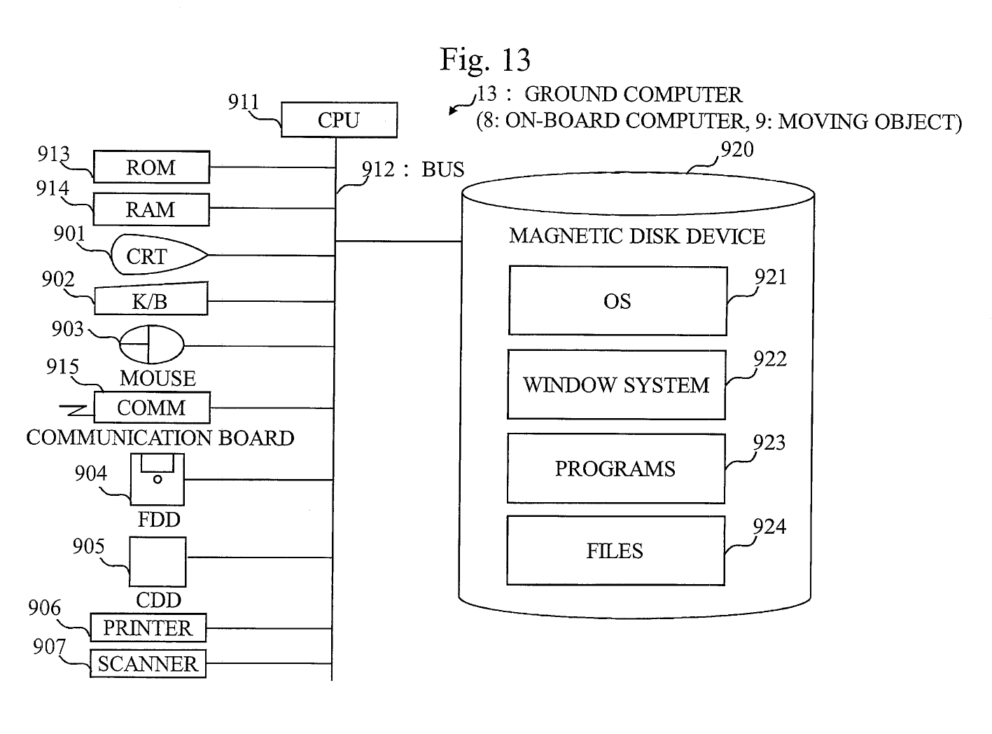

### DESCRIPTION OF REFERENCE SIGNS

1 flying vehicle
2 camera
3 navigation satellite
3a navigation satellite
3b navigation satellite
4 flying vehicle receiver
5 attitude sensor
6 attitude control actuator
7 view direction change device
8 on-board computer
9 moving object
10 earth
11 sight line of camera
12 ground station apparatus
13 ground computer
14 map database
15 terminal
16 flying vehicle database
17 image database
20 origin of coordinates
21 coordinate system
22a first target angle
22b second target angle
29 transfer destination device
31 image capture instruction unit
32 image synthesis unit
33 transfer unit
51 moving object information
52 communication information
71 image capture instruction signal
72 imagery data
73 synthesized image information
74 transfer destination information
75 transfer image information
81 coordinate position
82 transmission instruction
83 image capture request signal
84 receiving unit
85 communication satellite
86 observation satellite
87 communication satellite
88 quasi-zenith satellite
91 moving object receiving unit
92 request determination unit
93 image capture request transmission unit
94 display screen
95 communication unit
96 family-side base unit
97 elderly-person-side cordless handset
98 cellular phone handset
99 emergency switch
100 moving object image capture system
901 display device
902 keyboard
903 mouse
904 FDD
905 CDD
906 printer device
907 scanner device
910 system unit
911 CPU
912 bus
913 ROM
915 communication board
920 magnetic disk device
921 OS
922 window system
923 programs
924 files
931 telephone apparatus
932 facsimile machine
940 Internet
941 gateway
942 LAN

1. A moving object image capture system which captures an image of a moving object, comprising:
flying vehicles each of which includes a camera that captures an image of an earth surface and captures an image of the earth surface locating a specified coordinate position by the camera;
a moving object which receives distance measurement radio waves transmitted from navigation satellites to measure a coordinate position of the moving object and transmits an image capture request signal for requesting taking an image of the earth surface locating the measured coordinate position; and
a ground station apparatus which receives the image capture request signal from the moving object, selects one of the flying vehicles which takes the image of the earth surface locating the coordinate position of the moving object, transmits an image taking capture instruction signal for taking the image locating the coordinate position of the moving object to the selected flying vehicle, causes the camera mounted on the flying vehicle to capture the image of the earth surface locating the coordinate position of the moving object, and receives from the flying vehicle imagery data obtained by the image capture by the camera.

2. The moving object image capture system according to claim 1, wherein the moving object includes:
a moving object receiving unit which receives the distance measurement radio waves transmitted from the navigation satellites to measure the coordinate position; and
a request determination unit which determines whether or not the moving object has moved by a predetermined threshold or more, based on the coordinate position, and generates the image capture request signal.

3. The moving object image capture system according to claim 1, wherein the ground station apparatus includes:
a flying vehicle database which stores operation information on the flying vehicles; and
an image capture instruction unit which receives the image capture request signal from the moving object, selects a plurality of the flying vehicles based on the operation information stored in the flying vehicle database, and transmits the image capture instruction signal to the selected flying vehicles.

4. The moving object image capture system according to claim 1, wherein the ground station apparatus includes:
a map database which stores map information; and
an image synthesis unit which selects one of the map information corresponding to the imagery data from the map information stored in the map database and synthesizes the imagery data and the map information.

5. The moving object image capture system according to claim 1, wherein the ground station apparatus includes:
an image database which records imagery data taken in the past as recorded images; and
an image synthesis unit which selects one of the imagery data taken in the past corresponding to the imagery data from among the recorded images stored in the image database and synthesizes the imagery data and the recorded image.

6. The moving object image capture system according to claim 1, wherein the moving object generates and transmits the image capture request signal including transfer destination information indicating a transfer destination device to which the imagery data from the ground station apparatus is transferred; and
the ground station apparatus includes a transfer unit which generates transfer image information including the imagery data received from the flying vehicle and transfers the transfer image information to the transfer destination device indicated by the transfer destination information included in the image capture request signal transmitted by the moving object.

7. The moving object image capture system according to claim 1, wherein the flying vehicle takes a plurality of images obtained by changing image-taking specifications of the camera.

8. The moving object image capture system according to claim 1, further comprising:
a communication satellite which receives the image capture request signal transmitted by the moving object and transmits the image capture request signal to the ground station apparatus.

9. The moving object image capture system according to claim 1, comprising:
a quasi-zenith satellite;
wherein the quasi-zenith satellite is at least one of the navigation satellites and the flying vehicle.

10. A moving object comprising:
a moving object receiving unit which receives distance measurement radio waves transmitted from navigation satellites to measure a coordinate position of a moving object;
a request determination unit which determines whether or not the moving object has moved by a predetermined threshold or more, based on the coordinate position measured by the moving object receiving unit, and generates an image capture request signal for image-capturing the coordinate position; and
an image capture request transmission unit which transmits the image capture request signal for taking an image of an earth surface locating the coordinate position measured by the moving object receiving unit, based on a result of the determination by the request determination unit.

11. A ground station apparatus comprising:
an image capture instruction unit which receives from a moving object an image capture request signal including a coordinate position of the moving object, transmits an image capture instruction signal including the coordinate position of the moving object to a flying vehicle, and causes a camera mounted on the flying vehicle to capture an image of an earth surface locating the coordinate position of the moving object; and
a transfer unit which receives from the flying vehicle imagery data obtained by the image capture by the camera, generates transfer information including the imagery data, and transfers the transfer information to at least one of the moving object and a transfer destination device.

12. A moving object image capture method of a moving object image capture system which captures an image of a moving object, the method comprising:
by a moving object which receives distance measurement radio waves transmitted from navigation satellites and measures a coordinate position, transmitting an image capture request signal for requesting taking an image of an earth surface locating a measured coordinate position of a moving object;
by a ground station apparatus, receiving the image capture request signal from the moving object, selecting a flying vehicle which takes the image of the earth surface locating the coordinate position of the moving object, transmitting an image capture instruction signal for taking the image locating the coordinate position of the moving object, and instructing a camera mounted on the flying vehicle to capture the image of the earth surface locating the coordinate position of the moving object;
by the flying vehicle, receiving the image-taking instruction signal, capturing the image of the earth surface locating the coordinate position specified by the capture instruction signal using a camera which is mounted on the flying vehicle and captures an image of the earth surface, and transmitting imagery data to the ground station apparatus; and
by the ground station apparatus, receiving from the flying vehicle the imagery data obtained by the image-capturing by the camera.

13. A moving object comprising:
a moving object receiving unit which receives distance measurement radio waves transmitted from navigation satellites to measure a coordinate position of the moving object;
a request determination unit which determines whether or not there is an image capture request for image-capturing the coordinate position and generates an image capture request signal for image-capturing the coordinate position, based on the coordinate position measured by the moving object receiving unit; and
an image capture request transmission unit which transmits the image capture request signal for image-capturing an earth surface locating the coordinate position measured by the moving object receiving unit, based on a result of the determination by the request determination unit.

14. An observation satellite comprising:
a receiver which receives a distress signal transmitted by a moving object;
an extraction unit which analyzes the distress signal received by the the receiver and extracts position information on the moving object;
a camera which points to and captures an image of a coordinate position indicated by the position information on the moving object extracted by the extraction unit and obtains imagery data; and
a transmitter which transmits the imagery data obtained by the camera to a transfer destination device installed at a search and rescue department.
